(19) United States
(12) Patent Application Publication
(10) Pub. No.: US 2026/0100585 A1
(43) Pub. Date: Apr. 9, 2026

(54) SYSTEM AND METHOD FOR ENERGY GRID MANAGEMENT WITH CENTRALIZED INTELLIGENCE AND DYNAMIC EDGE CONFIGURATION

(71) Applicant: Euto Energy B.V., Amsterdam (NL)

(72) Inventor: Ali Karademir, Amsterdam (NL)

(21) Appl. No.: 19/350,062

(22) Filed: Oct. 6, 2025

Related U.S. Application Data
(60) Provisional application No. 63/703,911, filed on Oct. 5, 2024.

(51) Int. Cl. H02J 3/38; H02J 3/00; H02J 13/00

(52) U.S. Cl. CPC H02J 3/38; H02J 3/001; H02J 13/12; H02J 2103/35

(57) ABSTRACT

A system and method for dynamic energy grid management with centralized intelligence and distributed edge execution is disclosed. An energy grid optimization computer continuously receives operational data from edge units distributed throughout an energy distribution network. The computer monitors the data to detect trigger events such as renewable generation fluctuations or predicted grid congestion, performs system-wide analysis to identify affected edge units, calculates updated parameters accounting for variable fault current contributions from renewable sources, generates lightweight configuration packages, and deploys them to edge units through secure communication networks. Edge units receive configurations, perform validation, execute atomic rolling updates without interrupting operations, continuously sample measurements, autonomously execute protection and control algorithms, coordinate actions using GPS/PTP synchronized timing, and stream filtered operational data back to the central platform. The continuous configuration update methodology enables dynamic adaptation to variable renewable generation and changing grid conditions while maintaining millisecond-level autonomous protection response.

### CROSS-REFERENCE TO RELATED APPLICATIONS

This Application claims priority to U.S. Provisional Patent Application No. 63/703,911, filed on 5 Oct. 2024, entitled “SYSTEM AND METHOD FOR CENTRALIZED ENERGY MANAGEMENT IN SMART GRIDS”, the entire specifications of which are incorporated herein by reference.

### BACKGROUND OF THE INVENTION

### Field of the Art

The disclosure relates to the field of smart energy grid management systems, and more particularly to the field of adaptive coordination and control of energy systems with variable generation and consumption patterns.

### Discussion of the State of the Art

The energy infrastructure of modern society depends critically on reliable electrical power generation, transmission, and distribution systems. Electric grids are complex networks that deliver energy from production facilities through high, medium, and low voltage stations and substations to end users. Traditional grids generally operate on well-established principles with relatively predictable, unidirectional power flows from central generation facilities to distributed consumers.

These conventional systems have been managed through supervisory control and data acquisition (SCADA) systems, intelligent electronic devices (IEDs), and substation controllers. Protection and control are achieved through directional overcurrent relays and other protective devices with fixed settings that are typically configured manually and remain static for extended periods (often 15 to 20 years) without modification. Configuration changes, when necessary, are performed manually and infrequently, perhaps once per year at most. This static approach has been adequate when grid conditions were predictable and changed slowly.

Modern energy systems are undergoing a fundamental transformation that is rendering traditional grid management approaches inadequate. The replacement of centralized fossil fuel generation with distributed renewable energy sources such as solar photovoltaic systems and wind farms has introduced unprecedented complexity. Unlike conventional generators that produce predictable, controllable power output, renewable sources are inherently intermittent and variable. A passing cloud can dramatically reduce solar output within seconds; wind speeds can fluctuate unpredictably. This variability is not under operator control and cannot be easily predicted.

The integration of renewable energy at various distribution points, including rooftop installations and community solar farms, has fundamentally altered power flow patterns.

Traditional grids were designed for unidirectional flow from central facilities to consumers. With distributed generation, power now flows in both directions, creating complex, bi-directional flows that are highly fluctuating and significantly less predictable. Additionally, the replacement of large rotating generators with inverter-based resources has reduced the grid's inherent ability to resist frequency disturbances, making systems more vulnerable to instability.

Concurrent with renewable integration, the proliferation of high-consumption loads with variable demand patterns, such as electric vehicle charging stations and heat pumps, introduces additional complexity and demand volatility. These loads create sudden, significant demand spikes and are less predictable than traditional consumption patterns. The combination of variable generation and variable consumption create dynamic conditions that change within seconds or milliseconds.

Traditional grid management systems are fundamentally incompatible with these modern conditions. Static capacity allocations prevent efficient utilization of infrastructure. For example, analysis in the Netherlands indicates approximately seventy percent of technical grid capacity remains unused due to inflexible management structures. Line capacity can vary by up to forty percent depending on ambient temperature and weather, yet traditional systems cannot dynamically adjust to utilize this variable capacity.

Conventional protection systems using fixed relay settings calculated for predetermined fault scenarios are particularly problematic. Fault current levels in systems with renewable integration vary dramatically depending on real-time generation output. When a photovoltaic plant's output changes due to passing clouds, fault current contributions change correspondingly, potentially causing relay miscoordination where backup relays operate before primary relays, leading to unnecessary widespread outages.

Modern grids have evolved into complex ecosystems of interconnected, interdependent units, yet localized control decisions are made without holistic system knowledge. A substation controller cannot independently determine optimal dispatch decisions when congestion occurs elsewhere in the system, as it lacks knowledge of consumption and generation patterns in other regions. This absence of system-wide coordination prevents the optimization necessary to accommodate dynamic conditions.

Further, the manual configuration paradigm of traditional systems creates a fundamental operational bottleneck. Updating configurations requires manual intervention by engineers, often involving physical equipment access and manual parameter entry. This process is time-consuming, error-prone, and incompatible with grids where conditions can change in seconds. Software in traditional protection and control devices may remain unchanged for fifteen to twenty years, wholly insufficient for systems with rapidly fluctuating generation and load.

Therefore, there exists a significant need in the art for energy grid management systems that can provide system-wide intelligence and coordination while maintaining local autonomous operation capability for time-critical functions, adapt dynamically to rapidly changing conditions without manual intervention, maintain resilience to communication failures, and efficiently utilize available grid capacity in systems with high penetration of variable renewable generation and dynamic load patterns.

### SUMMARY OF THE INVENTION

According to a preferred embodiment of the invention, a system and method for dynamic energy grid management with centralized intelligence and distributed edge execution enables continuous adaptation to changing grid conditions through systematic configuration updates while maintaining millisecond-level autonomous protection and control at the grid edge.

In some aspects, the techniques described herein relate to a system for energy grid management comprising an energy grid optimization computer that continuously receives operational data from edge units including voltage measurements, current measurements, power flow information, generation capacity data from renewable sources, fault event notifications, and equipment status information, monitors this data to detect trigger events such as renewable generation fluctuations exceeding predetermined thresholds or predicted grid congestion, and responsive to trigger event detection performs system-wide analysis to identify affected edge units requiring configuration updates.

In some aspects, the techniques described herein relate to a system comprising an energy grid optimization computer with analyzer, optimizer, and configuration manager components, and multiple edge units each with communication interface, time synchronization interface, processor executing embedded software, configuration storage, configuration manager, and measurement and I/O control subsystem connected through Ether CAT protocol, wherein the continuous feedback loop between central configuration generation and edge autonomous execution enables dynamic grid adaptation while maintaining protection reliability.

In some aspects, the energy grid optimization computer calculates updated parameters accounting for variable fault current contributions from renewable sources, generates lightweight JSON-formatted configuration packages containing protection thresholds, control set-points, automation logic parameters, and coordination parameters, and deploys these configuration packages to connected edge units through secure communication networks while queuing configurations for disconnected edge units.

In some aspects, the edge units receive configuration packages, perform comprehensive validation including integrity verification, compatibility confirmation, and range checking, and execute atomic rolling updates using memory pointer switching to transition to new configurations without interrupting time-critical operations, achieving hot updates that maintain continuous protection and control throughout configuration changes.

In some aspects, the edge units continuously sample operational parameters at intervals of 250 microseconds or faster, process measurements through protection algorithms that autonomously issue trip commands when fault conditions are detected without waiting for central platform instructions, execute control algorithms for voltage regulation and power flow optimization, and coordinate with other edge units using GPS/PTP synchronized clocks for nanosecond-level timing precision enabling synchronized actions across geographically distributed locations.

In some aspects, the edge units filter and aggregate collected operational data through change-based filtering that transmits measurements only when values exceed predetermined change thresholds, aggregation that combines multiple measurements into summary statistics over time windows, and event-triggered transmission that immediately sends high-priority data when faults or alarms occur, substantially reducing communication bandwidth requirements while preserving critical information.

In some aspects, the edge units continuously monitor communication status and time synchronization status, automatically transition between operating modes based on detected conditions, operate in fully connected and synchronized mode with globally optimized configuration when both communication and synchronization are active, transition to connected but not synchronized mode excluding coordinated actions when time synchronization is lost, transition to unconnected mode with local safety-focused configuration when communication is lost, and execute resynchronization protocols upon restoration of connectivity.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram illustrating system architecture of an energy grid optimization computer and interconnected edge units deployed throughout a smart grid energy network, according to an embodiment of the invention.

FIG. 6 is a block diagram illustrating a detailed internal architecture of an edge unit, according to an embodiment of the invention.

FIG. 7 is a flowchart illustrating a method for continuous configuration generation by an energy grid optimization computer, according to an embodiment of the invention.

FIG. 8 is a flowchart illustrating a method of configuration reception, validation, and activation executed by an edge unit, according to an embodiment of the invention.

FIG. 9 is a state diagram illustrating the three primary operating modes of edge units, according to an embodiment of the invention.

FIG. 10 is a single-line diagram illustrating an exemplary distribution network topology with four edge units managing different geographical regions, according to an embodiment of the invention.

FIG. 11 is a single-line diagram illustrating a transmission substation supplying an industrial zone with multiple factory loads, according to an embodiment of the invention.

FIG. 12 is a single-line diagram illustrating a distribution network with integrated solar photovoltaic generation, according to an embodiment of the invention.

FIGS. 13A-13C are sequential single-line diagrams illustrating a temporal progression of fast frequency response to sudden solar generation loss, according to an embodiment of the invention.

### DETAILED DESCRIPTION

One or more different inventions may be described in the present application. Further, for one or more of the inventions described herein, numerous alternative embodiments may be described; it should be appreciated that these are presented for illustrative purposes only and are not limiting the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any practical order. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

“Rolling update” refers to—A configuration activation mechanism that transitions an edge unit from an old configuration to a new configuration without interrupting time-critical protection and control operations, implemented as an atomic operation using memory pointer switching where a single pointer variable is updated to reference a new configuration memory region in a single processor instruction cycle, ensuring instantaneous transition without intermediate partial states or system reboots.

“Configuration package” refers to a lightweight data structure, preferably in JSON format, containing a unique configuration identifier, version number, timestamp, target edge unit identifier, and a complete set of operational parameters organized by functional category including protection thresholds, control set-points, automation logic parameters, and coordination parameters, typically ranging from a few kilobytes to several hundred kilobytes depending on edge unit functionality complexity.

“Edge unit” refers to a distributed hardware unit located at critical nodes in the energy grid (such as distribution substations or transmission substations) comprising a processor executing embedded edge software, communication interface for bidirectional data exchange with a central platform, time synchronization interface providing GPS or PTP time reference, configuration storage, and measurement and I/O control subsystem, capable of autonomous millisecond-level protection and control operations while coordinating with system-wide intelligence.

“Trigger event” refers to a condition detected through continuous monitoring of operational data that necessitates configuration updates, including renewable generation fluctuations exceeding predetermined thresholds, predicted grid congestion within an upcoming time period, fault conditions requiring coordinated protection scheme adjustments, connection or disconnection of significant generation or load assets, forecasted weather events affecting line capacity or renewable output, or periodic scheduled updates based on accumulated operational data.

“Atomic operation” (in context of configuration updates) refers to a configuration activation process that completes in a single indivisible step without any intermediate state where parameters are undefined or inconsistent, implemented through memory pointer switching that executes in a single processor instruction cycle to ensure true atomicity in transitioning between configurations.

“Hot update” refers to a configuration or software update mechanism that modifies operational parameters or embedded software without requiring edge unit reboot, service interruption, or cessation of time-critical protection and control functions, maintaining continuous grid protection throughout the update process.

“Ether CAT” refers to Ethernet for Control Automation Technology, a deterministic real-time industrial Ethernet protocol providing precise timing guarantees for data acquisition and command output between edge unit processors and measurement and I/O control subsystems, enabling guaranteed cycle completion times essential for protection and control applications.

“Fault current contribution” refers to the amount of electrical current supplied to a fault location by a particular generation source, particularly relevant for inverter-based renewable energy sources where fault current varies proportionally with generation output level unlike traditional synchronous generators with relatively constant fault contribution.

Coordination time interval (CTI) refers to the predetermined time difference between primary relay operation and backup relay operation (typically 300 milliseconds) that must be maintained to ensure proper protection coordination where the primary relay clears faults before backup relays operate, preventing unnecessary widespread outages.

“Change-based filtering” refers to a data transmission optimization technique where measurements are transmitted only when values change by more than a predetermined threshold, avoiding redundant transmission of steady-state values and reducing communication bandwidth requirements.

“Event-triggered transmission” refers to a data communication methodology where high-priority information such as fault detections, protection device operations, or alarm conditions is transmitted immediately with minimal delay upon event occurrence, ensuring rapid system-wide awareness of critical conditions.

“Configuration version” refers to a unique identifier assigned to each configuration package enabling tracking of which operational parameters are active at each edge unit, facilitating configuration deployment status monitoring and ensuring accurate system-wide configuration state awareness.

“Failsafe configuration” refers to a pre-loaded operational parameter set designed for use during communication outages, emphasizing conservative protection settings with reduced pickup thresholds and shorter time delays to ensure fault detection and equipment protection even if slightly increasing nuisance trip risk, prioritizing safety over optimization.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

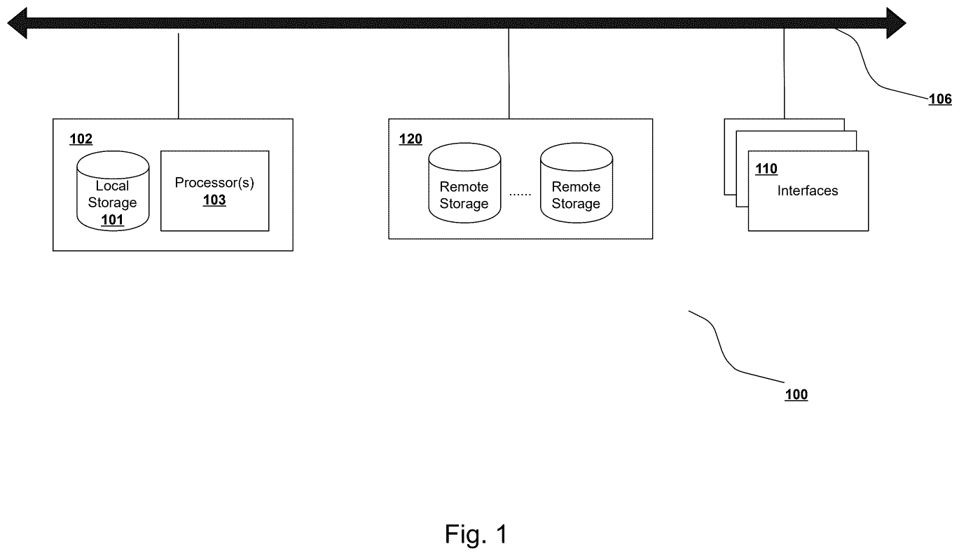

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software-or hardware-based instructions according to one or more programs stored in memory. Computing device 100 may be adapted to communicate with a plurality of other computing devices, such as clients or servers, over communications networks such as a wide area network, a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random-access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs).

Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).
Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

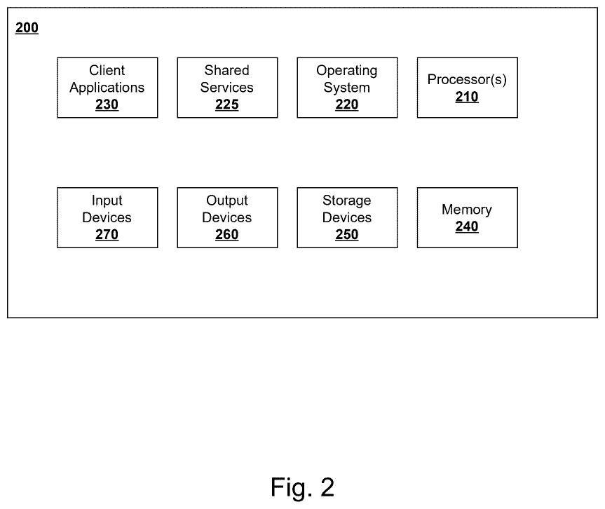

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

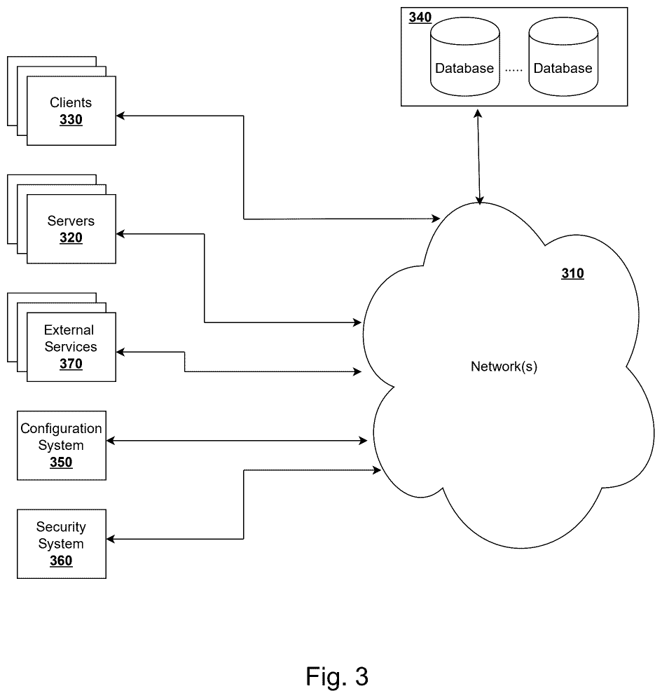

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprises or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

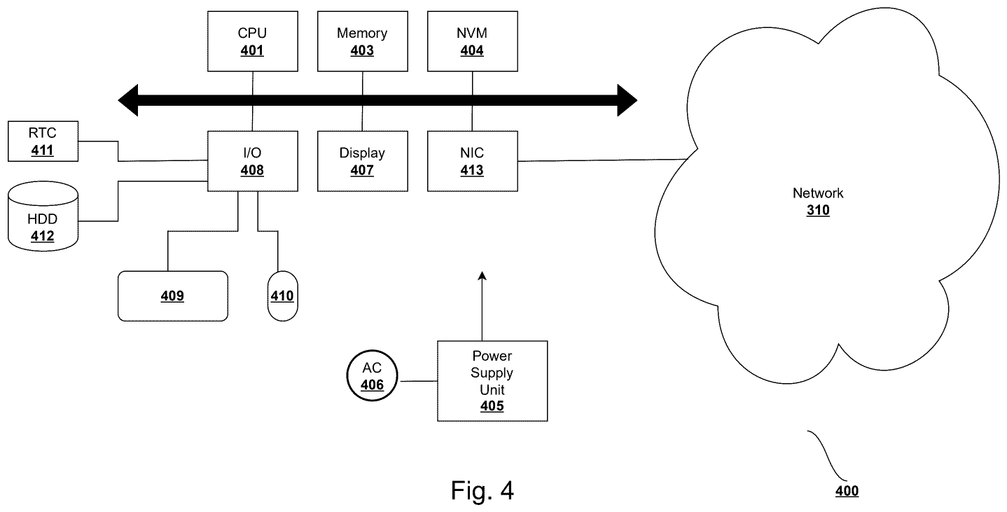

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

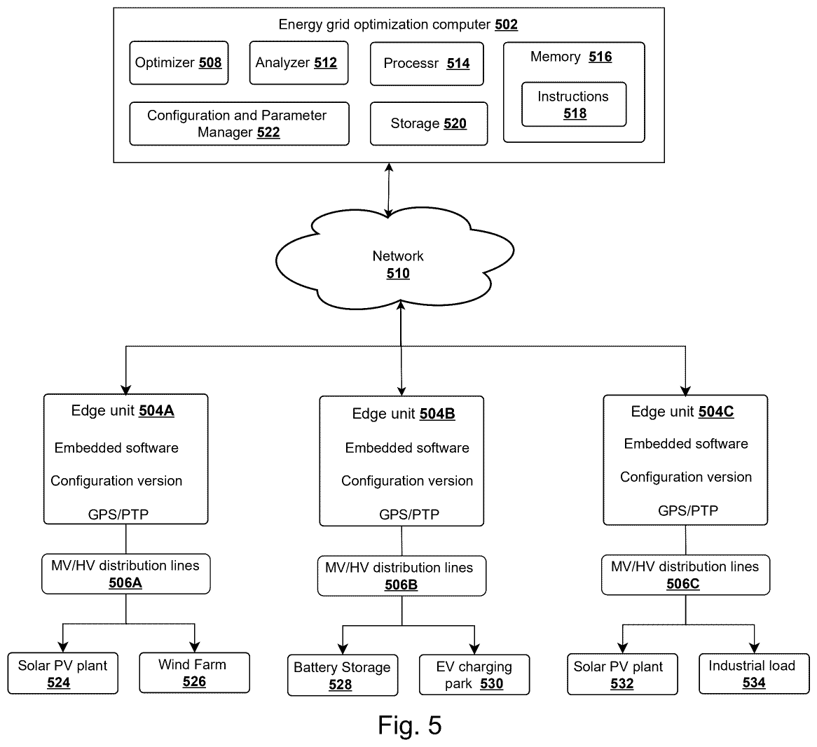

FIG. 5 is a block diagram illustrating system architecture of an energy grid optimization computer 502 and interconnected edge units deployed throughout a smart grid energy network, according to an embodiment of the invention.

In an embodiment, energy grid optimization computer 502 include processor 514, memory 516 containing instructions 518, storage 520, configuration and parameter manager 522, analyzer 512, and optimizer 508. These components collectively enable centralized intelligence and system-wide optimization of the distributed energy grid.

In an embodiment, energy grid optimization computer 502 may communicate with multiple edge units (504A, 504B, 504C) via network 510, which may comprise secure communication channels using protocols such as TLS over TCP/IP, cellular networks, or dedicated utility communication infrastructure. Each edge unit is strategically positioned at critical nodes within the smart grid to manage specific geographical regions or functional subsystems.

While FIG. 5 illustrates three edge units (504A, 504B, 504C) for clarity of presentation, practical implementations of the system typically deploy dozens to hundreds of edge units throughout the smart grid network depending on system size and complexity. Energy grid optimization computer 502 may be designed to scale to manage large numbers of edge units, with the architecture supporting simultaneous communication, configuration deployment, and coordination across the entire fleet of deployed units. The descriptions that follow use edge unit 504A as the representative example, with the understanding that edge units 504B, 504C, and any additional edge units not explicitly shown implement equivalent functionality tailored to their specific substation locations and connected assets

In an embodiment, edge unit 504A may be connected to medium voltage/high voltage (MV/HV) distribution lines 506A and manages solar PV plant 524 and wind farm 526. Edge unit 504A contains embedded software that executes protection, control, and automation algorithms according to configuration parameters deployed from energy grid optimization computer 502. The embedded software operates autonomously at millisecond-level cycle times while remaining synchronized with system-wide intelligence. Edge unit 504A incorporates GPS/PTP (Precision Time Protocol) time synchronization capabilities enabling nanosecond-level coordination with other edge units for synchronized control actions. The configuration version stored in edge unit 504A represents the currently active operational parameters defining protection thresholds, control set-points, and automation logic sequences.

In an embodiment, edge unit 504B may interface with MV/HV distribution lines 506B and coordinate with battery storage 528 and EV charging park 530. The battery storage system provides fast frequency response capabilities and grid stabilization services, while the EV charging park represents a significant variable load that requires dynamic management to prevent grid congestion. Edge unit 504B similarly contains embedded software, maintains configuration versioning, and utilizes GPS/PTP synchronization to ensure coordinated operation within the broader grid context.

GPS/PTP synchronization is a time synchronization methodology using Global Positioning System (GPS) satellite signals and/or Precision Time Protocol (IEEE 1588) network-based clock synchronization to achieve nanosecond-level timing accuracy across geographically distributed edge units, enabling coordinated actions through common time reference.

In an embodiment, edge unit 504C may connect to MV/HV distribution lines 506C and manages solar PV plant 532 alongside industrial load 534. The industrial load represents predictable consumption patterns that can be forecasted and optimized, while the solar PV plant introduces variable generation dependent on weather conditions. Edge unit 504C executes the same embedded software architecture with GPS/PTP synchronization and maintains its specific configuration version tailored to the characteristics of its managed assets.

The operational architecture depicted in FIG. 5 demonstrates the continuous bidirectional data flow that characterizes the hybrid intelligence framework. Energy grid optimization computer 502 continuously receives filtered operational data from edge units 504A-C through network 510. This data includes voltage and current measurements sampled at high frequencies (typically every 250 microseconds via EtherCAT process bus communication), equipment status indicators, fault event notifications, and performance metrics. Analyzer 512 processes these incoming data streams to perform system-wide state analysis including voltage stability assessment, frequency monitoring, and power flow calculations.

In an embodiment, optimizer 508 may employ AI/ML algorithms including reinforcement learning for dispatch optimization and neural networks for load prediction to generate optimal operational strategies. When trigger events are detected configuration and parameter manager 522 calculates updated parameters for affected edge units. These calculations account for variable fault current contributions from renewable sources, which change proportionally with generation output, necessitating adaptive relay coordination to prevent misoperation. Examples of trigger events may include renewable generation fluctuations exceeding predetermined thresholds, predicted grid congestion, fault conditions, or connection/disconnection of significant generation or load assets.

In an embodiment, configuration and parameter manager 522 may generate lightweight JSON-formatted configuration packages containing protection thresholds and set-points, control logic parameters, operational rules, and algorithm activation flags. These configuration files are transmitted through network 510 to target edge units using secure communication protocols. The configuration deployment process is designed to be nearly atomic, with edge units performing hot updates that switch from old configurations to new configurations without requiring system reboots or interrupting time-critical protection operations. Configuration and parameter manager 522 may maintain version tracking across all edge units, ensuring that the system can validate which configuration is active at each location and coordinate synchronized deployment when multiple edge units require simultaneous updates.

In an embodiment, storage 520 may include archives of long-term operational data from all edge units, past configuration versions and their performance outcomes, and historical patterns used for AI training. This historical data enables continuous improvement of forecasting algorithms and optimization strategies. The stored data supports forensic analysis following grid disturbances, allowing operators to reconstruct event sequences and refine protection schemes based on actual operational experience.

In an embodiment, network 510 may be implemented using various physical communication technologies including fiber optic networks (most common for substations providing high bandwidth and low latency), cellular networks (4G/5G for remote locations where wired infrastructure is impractical), satellite communications (for extremely remote sites), or private MPLS networks (utility-owned infrastructure). Industrial communication protocols are layered on top of the physical network infrastructure, including IEC 61850 (the substation automation standard defining data models and communication methods), DNP3 (Distributed Network Protocol for SCADA systems), Modbus TCP/IP, and MQTT for IoT-style communication. The system architecture incorporates resilience to network failures, with edge units capable of autonomous operation using their last valid configuration when network 510 connectivity is lost, then automatically resynchronizing upon restoration of communication.

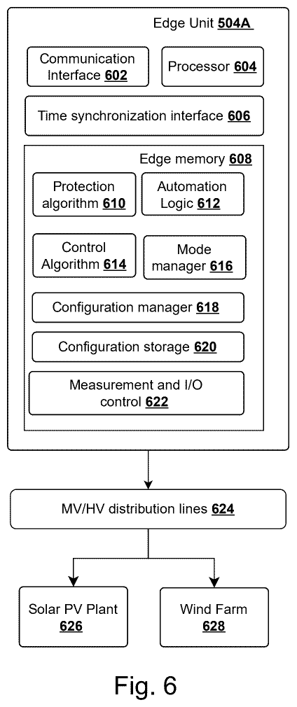

FIG. 6 is a block diagram illustrating a detailed internal architecture of an edge unit 504A, according to an embodiment of the invention. Edge unit 504A shown in FIG. 6 is representative of the embedded intelligence and autonomous operational capabilities present in all edge units deployed throughout the system, according to an embodiment of the invention. Edge unit 504A includes communication interface 602, processor 604, time synchronization interface 606, edge memory 608, and measurement and I/O control subsystem 622, which collectively enable millisecond-level autonomous execution of protection, control, and automation functions while maintaining coordination with system-wide intelligence.

In an embodiment, communication interface 602 manages bidirectional data exchange with energy grid optimization computer 502 through network 510. Communication interface 602 receives configuration data packages and software updates transmitted from energy grid optimization computer 502, temporarily staging incoming files in memory before validation and activation. Communication interface 602 transmits filtered operational data, status reports, event logs, and performance metrics back to energy grid optimization computer 502. The filtering process reduces communication bandwidth requirements by applying change-based triggers (transmitting new measurements only when values change beyond predetermined thresholds), periodic updates (confirming continued operation at intervals ranging from seconds to minutes even during steady-state), and event-triggered transmission (immediately sending high-priority data when faults, protection operations, or alarm conditions occur). Communication interface 602 implements buffering mechanisms that accumulate data during temporary communication outages, preventing data loss and enabling complete operational record reconstruction upon connectivity restoration.

In an embodiment, time synchronization interface 606 provides high-precision time reference using GPS (Global Positioning System) and/or PTP (Precision Time Protocol, IEEE 1588) technologies. GPS receivers provide absolute time reference from satellites with accuracy typically within 100 nanoseconds, requiring outdoor antenna installation with satellite visibility. PTP synchronizes clocks over Ethernet networks using master-slave clock hierarchy, achieving accuracy better than 1 microsecond and often reaching nanosecond-level precision with hardware-assisted implementations. Time synchronization interface 606 may employ hybrid GPS and PTP architectures where GPS establishes the absolute time reference and PTP distributes this reference across local network infrastructure. The nanosecond-level synchronization provided by time synchronization interface 606 enables Synchrophasors measurements (measuring voltage and current at different geographical locations with common time reference), coordinated protection actions (multiple edge units tripping circuit breakers simultaneously to isolate faults), precise fault location (comparing timestamps from different units to calculate fault position), and system-wide coordination where one edge unit's action at time T triggers predetermined responses from other edge units at time T+Δ.

In an embodiment, processor 604 executes the embedded edge software stored in edge memory 608, implementing the real-time control loop that continuously samples measurements, processes protection and control algorithms, and issues commands to field equipment. Processor 604 operates in deterministic cycles with guaranteed maximum execution times, typically completing each cycle within 1 to 5 milliseconds for control operations and even faster for protection functions. This deterministic operation ensures predictable response times critical for fault clearing and equipment protection.

In an embodiment, edge memory 608 may include protection algorithm 610, that implements overcurrent detection, undervoltage detection, overvoltage detection, frequency deviation detection, rate-of-change calculations, and directional determination.

In an embodiment, protection algorithm 610 may be a software executing on edge unit processors that continuously evaluates measured voltage and current values to detect fault conditions including overcurrent, undervoltage, overvoltage, frequency deviation, and abnormal rate-of-change, comparing measurements against threshold parameters and issuing autonomous trip commands to circuit breakers when fault conditions are detected.

Protection algorithm 610 continuously compares measured values against threshold parameters defined in configuration storage 620, applying time delays specified by time dial settings and employing inverse-time characteristics appropriate for coordinating with upstream and downstream protection devices. When protection algorithm 610 detects fault conditions requiring protective action, edge unit 504A immediately issues trip commands to circuit breakers through measurement and I/O control 622 without waiting for instructions from energy grid optimization computer 502, ensuring millisecond-level autonomous response essential for limiting equipment damage and preventing fault propagation.

In an embodiment, automation logic 612 executes sequences including load shedding priorities, generation dispatch order, and automatic reconfiguration following faults. Automation logic 612 implements self-healing functionality where, upon detecting and isolating a fault, edge unit 504A coordinates with other edge units to establish alternative supply paths and restore service to loads that can be re-energized through different feeder routes. This coordination is achieved through two mechanisms: for time-critical coordinated actions requiring nanosecond-level synchronization, automation logic 612 uses timestamps from time synchronization interface 606 to execute actions at predetermined absolute times; for coordination requiring information exchange but not nanosecond precision, automation logic 612 communicates through energy grid optimization computer 502 which calculates appropriate responses and deploys updated configurations.

In an embodiment, control algorithm 614 may implement voltage regulation, frequency control, and power flow optimization according to control set-points specified in configuration storage 620. Control algorithm 614 is a software executing on edge unit processors that implements voltage regulation, frequency control, and power flow optimization by adjusting transformer tap changers, switching capacitor banks, modifying voltage regulator set-points, and controlling power electronic converter outputs according to control set-points specified in active configurations.

Control algorithm 614 adjusts transformer tap changers, switches capacitor banks, modifies voltage regulator positions, and controls power electronic converter outputs to maintain voltage within acceptable limits (typically ±5% of nominal), regulate reactive power for power factor correction, and optimize power flows to minimize losses. Control actions typically update at rates ranging from every few AC cycles (100-200 milliseconds for fast voltage control) to every few seconds (for slower optimization functions) depending on the specific control objective.

In an embodiment, configuration manager 618 handles reception, validation, and activation of configuration packages received from energy grid optimization computer 502. When a new configuration arrives at communication interface 602, configuration manager 618 stores it temporarily in separate memory regions from the active configuration. Configuration manager 618 may perform integrity validation (verifying cryptographic checksums and data structure consistency), compatibility validation (confirming appropriateness for the specific edge unit hardware and software versions), and range validation (checking that parameter values fall within acceptable operational limits). Upon successful validation, configuration manager 618 may execute hot updates using atomic pointer switch mechanisms where a single pointer variable is updated to reference the new configuration memory region instead of the old region, completing the switch in a single processor instruction cycle to ensure true atomic behavior without intermediate inconsistent states.

In an embodiment, configuration storage 620 may maintain multiple configuration versions including the currently active configuration, the most recent validated configuration ready for activation, and previous stable configurations available for rollback if needed. Configuration storage 620 may track configuration version identifiers enabling configuration and parameter manager 522 to maintain accurate system-wide inventory of deployed configurations. Each configuration specifies operational mode parameters tailored to edge unit 504A's connection and synchronization status.

In an embodiment, mode manager 616 continuously monitors communication link status with energy grid optimization computer 502 and time synchronization status with other edge units. Mode manager 616 may implement automatic mode transitions based on detected conditions. When communication is lost for more than a predetermined timeout period (typically 500 milliseconds), mode manager 616 transitions from connected and synchronized mode to unconnected mode, activating a locally-optimized safety-focused configuration; when time synchronization degrades beyond an acceptable threshold (typically 10 microseconds drift) while communication remains active, mode manager 616 transitions to connected but not synchronized mode, continuing to receive configuration updates but suspending operations requiring precise timing coordination with other units; upon restoration of communication or time synchronization, mode manager 616 executes re-synchronization protocols that upload buffered operational data collected during degraded modes, receive updated configurations accounting for any system changes during the outage, and return to connected and synchronized mode with full operational capability.

In an embodiment, measurement and I/O control subsystem 622 may interface with MV/HV distribution lines 624 through instrument transformers including current transformers (CTs) and potential transformers (PTs) that scale high voltage and high current values to safe levels for electronic measurement. Measurement and I/O control subsystem 622 may connect to solar PV plant 626 and wind farm 628 through standard utility communication protocols. While FIG. 6 illustrates solar PV plant 626 and wind farm 628 as representative renewable energy sources, edge unit 504A may similarly interface with other distributed energy resources including additional solar installations, wind turbines, battery energy storage systems, combined heat and power (CHP) generators, fuel cells, or any other generation or storage assets present at the substation location, with measurement and I/O control subsystem 622 adapted to communicate with each asset type using appropriate protocols.

Measurement and I/O control subsystem 622 digitizes analog sensor signals using high-speed analog-to-digital converters, typically sampling at 250 microsecond intervals or faster to capture transient phenomena. The digitized measurements are communicated to processor 604 through EtherCAT (Ethernet for Control Automation Technology), a deterministic real-time industrial Ethernet protocol originally developed for precision machine control applications requiring microsecond-level timing accuracy and reliability. EtherCAT provides guaranteed message delivery times and precise synchronization between measurement and I/O control subsystem 622 and processor 604, enabling the deterministic execution cycles essential for protection and control applications.

In an embodiment, measurement and I/O control subsystem 622 may provide digital output channels that processor 604 uses to issue commands to circuit breakers, switches, voltage regulators, and other controllable field equipment. These output commands translate abstract decisions made by protection algorithm 610, control algorithm 614, and automation logic 612 into physical actions on grid equipment, such as trip signals that cause circuit breakers to open and interrupt fault current within 50-80 milliseconds (typical breaker operating time), close signals that energize circuit breakers to restore service, tap change commands that adjust transformer ratios for voltage regulation, and capacitor switching commands that modify reactive power compensation.

### Detailed Description of Exemplary Embodiments

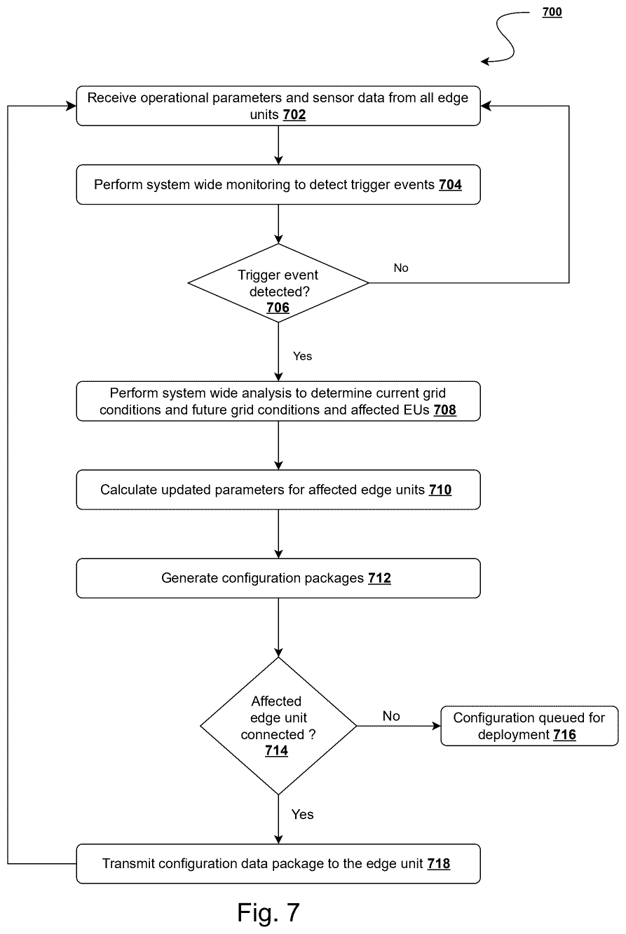

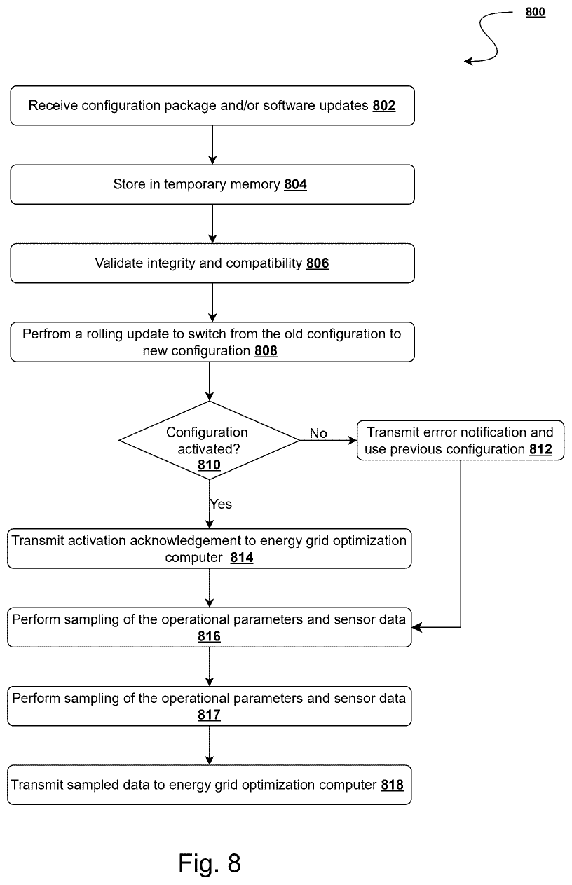

FIGS. 7 and 8 illustrate complementary perspectives of the continuous configuration update methodology that enables dynamic grid adaptation, with FIG. 7 depicting operations executed by energy grid optimization computer 502 (the central intelligence perspective) and FIG. 8 depicting operations executed by edge units such as edge unit 504A (the distributed edge intelligence perspective). These two methods operate concurrently and interdependently throughout system operation, forming a closed feedback loop where method 700 generates and deploys configurations based on system-wide analysis while method 800 receives, validates, and executes those configurations at the grid edge while streaming operational data back to energy grid optimization computer 502.

The temporal relationship between these methods is continuous rather than sequential. While method 700 proceeds through its monitoring and configuration generation cycle, multiple instances of method 800 execute simultaneously at all deployed edge units, each continuously receiving data, executing protection and control operations, and transmitting filtered operational data. When method 700 generates configuration packages at step 712 and deploys them at step 716, these packages are received by method 800 at step 802, creating the linkage between central intelligence and edge execution. Similarly, operational data transmitted by method 800 at step 818 is received by method 700 at step 702, closing the feedback loop that enables continuous adaptation to evolving grid conditions.

This architectural separation between central configuration generation (method 700) and edge configuration execution (method 800) provides several critical benefits: it enables system-wide optimization through centralized analysis while maintaining millisecond-level autonomous response at the edge; it allows configurations to be calculated considering global system state while permitting edge units to operate independently during communication outages; and it facilitates coordinated actions across multiple edge units through synchronized configuration deployment and GPS/PTP time references without requiring real-time communication between edge units during actual operational execution.

FIG. 7 is a flowchart illustrating method 700 for continuous configuration generation and deployment executed by energy grid optimization computer 502, according to an embodiment of the invention. Method 700 implements a centralized intelligence that enables dynamic adaptation to changing grid conditions through systematic monitoring, analysis, and configuration updates.

At step 702, energy grid optimization computer 502 may receive operational parameters and sensor data from all edge units 504A-C deployed throughout the energy grid. This data reception occurs continuously as edge units stream filtered measurements including voltage and current values (phase voltages, line currents, real power, reactive power, apparent power, power factor, and frequency), power flow information (magnitude and direction of real and reactive power through transmission and distribution lines), generation capacity data from renewable sources (current output levels from solar PV installations and wind farms, including trend data indicating whether output is increasing, decreasing, or stable), fault event notifications (transmitted immediately when protective algorithms detect abnormal conditions, including fault type such as overcurrent or undervoltage, fault location, magnitude of disturbance, and actions taken), and equipment status information (operational state of circuit breakers, switches, voltage regulators, capacitor banks, and other controllable assets).

The data reception at step 702 occurs at varying frequencies optimized for each data type's criticality and volatility. Voltage and current measurements are transmitted from each edge unit at predetermined intervals typically ranging from every 250 microseconds for continuous analog measurements to every few seconds for slower-changing parameters, depending on the measurement point's criticality to protection and control functions. Phase voltages, line currents, power factor, and frequency data are collected from instrument transformers and sensor systems at each substation location, with sampling synchronized to AC cycle timing for accurate phasor calculations.

Before transmission, each edge unit may perform filtering and preprocessing to reduce communication bandwidth requirements. Rather than transmitting continuous raw sensor data sampled at 250 microsecond intervals (which would generate approximately 4,000 samples per second per measurement channel), edge units transmit only relevant changes and periodic status updates. High-frequency oscillations are filtered out while preserving information about significant events and trends through data aggregation over time windows. For example, voltage measurements might be averaged over one-second intervals with minimum and maximum values also reported, reducing data volume by three orders of magnitude while retaining information about voltage variation patterns essential for power quality assessment and control optimization.

At step 704, energy grid optimization computer 502 performs system-wide monitoring to detect trigger events that necessitate configuration updates. Analyzer 512 implements pattern recognition algorithms to identify conditions including renewable generation fluctuations exceeding predetermined thresholds (for example, solar plant output change greater than 10% within a 5-minute window indicating significant weather events), predicted grid congestion within an upcoming time period (forecasted by analyzing load growth trends and generation availability), detection of fault conditions requiring coordinated protection scheme adjustments across multiple edge units, connection or disconnection of significant generation or load assets that alter system topology and protection requirements, forecasted weather events that will affect line capacity (temperature changes impacting thermal ratings) or renewable output (approaching cloud banks or wind pattern shifts), and periodic scheduled updates to optimize system performance based on accumulated operational data and refined AI models.

At step 706, energy grid optimization computer 502 may determine whether a trigger event has been detected. If no trigger event is identified, method 700 returns to step 702 to continue receiving operational data and monitoring system status. The continuous monitoring loop operates without interruption, ensuring that energy grid optimization computer 502 maintains real-time awareness of grid conditions and can respond immediately when trigger events occur.

The data reception at step 702 occurs at varying frequencies optimized for each data type's criticality and volatility. Voltage and current measurements are transmitted from each edge unit at predetermined intervals typically ranging from every 250 microseconds for continuous analog measurements to every few seconds for slower-changing parameters, depending on the measurement point's criticality to protection and control functions. Phase voltages, line currents, power factor, and frequency data are collected from instrument transformers and sensor systems at each substation location, with sampling synchronized to AC cycle timing for accurate phasor calculations.

Before transmission, each edge unit performs filtering and preprocessing to reduce communication bandwidth requirements. Rather than transmitting continuous raw sensor data sampled at 250 microsecond intervals (which would generate approximately 4,000 samples per second per measurement channel), edge units transmit only relevant changes and periodic status updates. High-frequency oscillations are filtered out while preserving information about significant events and trends through data aggregation over time windows. For example, voltage measurements might be averaged over one-second intervals with minimum and maximum values also reported, reducing data volume by three orders of magnitude while retaining information about voltage variation patterns essential for power quality assessment and control optimization.

At step 708, energy grid optimization computer 502 performs system-wide analysis to determine current grid conditions, forecast future grid conditions, and identify affected edge units (EUs) requiring configuration updates. This analysis is executed by configuration and parameter manager 522 in coordination with analyzer 512, implementing a multi-stage evaluation process that determines which edge units require configuration modifications and what specific parameter changes are necessary.

Configuration and parameter manager 522 may identify which edge units are directly affected by the detected trigger event. For a renewable generation fluctuation at edge unit 504A, the directly affected unit is obviously 504A itself, but configuration and parameter manager 522 also evaluates which other edge units have protection zones that could see changed fault current contributions due to the generation change, control regions that may experience voltage or power flow impacts, or coordination relationships requiring synchronized parameter adjustments to maintain system-wide protection coordination. This identification process considers network topology (which lines connect to which substations), electrical coupling strength (how strongly conditions at one location affect conditions at another, typically determined through power flow sensitivity analysis), protection coordination schemes (which relays serve as primary protection and which provide backup for each fault location), and operational constraints (line thermal limits, voltage limits, equipment ratings).

The analysis at step 708 leverages a digital twin model maintained by analyzer 512 that represents the complete electrical characteristics of the smart grid including impedances of all transmission and distribution lines, transformer ratings and tap positions, generator characteristics and operating points, load patterns at all consumption nodes, and renewable generation profiles at all distributed energy resource locations.

In an embodiment, digital twin model is a computational model maintained by the energy grid optimization computer representing complete electrical characteristics of the energy distribution network including line impedances, transformer ratings, generator characteristics, load patterns, and renewable generation profiles, used to simulate effects of different parameter combinations before deploying configurations to physical edge units.

Configuration and parameter manager 522 may use this digital twin to simulate the effects of different parameter combinations, evaluating how proposed relay settings would perform under various fault scenarios, whether proposed voltage set-points would maintain acceptable voltages throughout the network, and whether proposed coordination parameters would achieve desired system-wide behavior. The simulation capability enables configuration and parameter manager 522 to identify optimal settings before deploying them to physical edge units, reducing the risk of miscoordination or suboptimal performance.

Analyzer 512 evaluates system-wide power flow using load flow algorithms that calculate voltage magnitudes and angles at all buses, power flows through all transmission and distribution lines, and losses throughout the system under current conditions and forecasted future conditions. Analyzer 512 assesses voltage stability by calculating voltage stability indices (such as V-Q sensitivity or continuation power flow margins) and identifying buses approaching voltage collapse conditions where small load increases would cause large voltage drops. Analyzer 512 performs fault current calculations that account for variable contributions from renewable sources, recognizing that fault current from inverter-based resources changes proportionally with generation output unlike traditional synchronous generators with relatively constant fault contribution. For example, a solar PV plant operating at 5 MW capacity might contribute 1,500 amperes to a three-phase fault, but when cloud coverage reduces output to 1.5 MW, the fault contribution drops proportionally to approximately 450 amperes, significantly affecting the fault current seen by protective relays and necessitating adjusted settings to maintain coordination.

The system-wide analysis at step 708 includes forecasting future conditions using AI/ML models implemented in optimizer 508 that predict renewable generation patterns (incorporating weather forecasts obtained from external meteorological services, satellite imagery showing cloud movement and wind patterns, historical generation patterns for similar meteorological conditions, and real-time generation trend data indicating whether output is currently increasing or decreasing), anticipated load demand (based on historical consumption patterns, time of day and day of week effects, seasonal factors affecting heating and cooling loads, weather forecasts affecting temperature-sensitive loads, and scheduled industrial operations communicated by large consumers), and predicted grid congestion (identifying lines and transformers likely to approach thermal limits based on forecasted generation and load patterns combined with ambient temperature forecasts affecting equipment thermal ratings). The forecasting enables proactive configuration deployment where edge units receive updated parameters before conditions change rather than reacting after problems occur, implementing a predictive rather than reactive control philosophy.

Based on the system-wide analysis, configuration and parameter manager 522 identifies which edge units require configuration updates. For example, when a solar plant output drop is detected at edge unit 504A, the analysis may determine that edge units 504B and 504C also require updates: edge unit 504B may need to prepare its battery storage system for fast frequency response by activating discharge-ready mode and loading frequency-droop control parameters, while edge unit 504C may need adjusted protection settings accounting for reduced fault current contribution from the affected solar plant that changes the total fault current magnitude seen by relays protecting lines between 504A and 504C. The multi-unit impact assessment ensures that system-wide effects of local changes are addressed through coordinated configuration updates across all affected portions of the grid.

At step 710, configuration and parameter manager 522 may calculate updated parameters for affected edge units identified in step 708. For protection parameters, the calculation determines appropriate pickup current settings, time dial settings, and directional elements for overcurrent relays, accounting for current and predicted fault current levels that vary based on renewable generation output and grid topology. For a three-phase fault on a line with a solar PV plant, when the solar plant operates at full 5 MW capacity contributing approximately 1,500 amperes fault current, the relay coordination must account for total fault current including both grid contribution (approximately 8,000 amperes) and solar contribution (1,500 amperes). When cloud coverage reduces solar output to 1.5 MW, the solar fault contribution drops to approximately 450 amperes, requiring adjusted relay settings to maintain proper coordination time intervals between primary and backup protection devices.

Control set-points calculated at step 710 achieve optimal voltage regulation, frequency response, and power flow distribution. For voltage control, calculations determine transformer tap positions, voltage regulator settings, and capacitor bank switching schedules that maintain voltage within acceptable limits (typically 0.95 to 1.05 per unit) at all network nodes while minimizing reactive power flows and associated losses. For frequency control, calculations specify generator set-points, battery storage dispatch commands, and load shedding thresholds that maintain system frequency within narrow bands (typically ±0.05 Hz of nominal 60 Hz) despite variable renewable generation and load fluctuations. For power flow optimization, calculations determine optimal dispatch of available generation resources, transformer tap positions to control power flows, and phase shifter angles (if present) to minimize system losses while respecting line thermal limits and voltage constraints.

The protection parameter calculations at step 710 account for the variable nature of fault current contributions from renewable generation sources. When a large photovoltaic plant's output increases from 1.5 MW to 5 MW due to improving weather conditions, the fault current contribution from that inverter-based resource increases proportionally from approximately 450 amperes to 1,500 amperes for a three-phase fault near the plant. This variable fault current contribution affects the total fault current seen by all relays protecting lines downstream of the PV plant. Configuration and parameter manager 522 calculates relay pickup current settings and time dial settings that maintain proper coordination between primary and backup protection devices across the full range of possible PV output levels, ensuring that the primary relay always operates before the backup relay regardless of whether the PV plant is generating at minimum capacity (night-time or heavy cloud cover), maximum capacity (clear sunny conditions), or any intermediate level.

For example, consider a distribution line protected by primary relay R1 at the sending end and backup relay R2 upstream. Without the PV plant, fault current for a fault at the far end of the line might be 8,000 amperes from the grid source. With the 5 MW PV plant connected mid-line, the fault current seen by R1 increases to 9,500 amperes (8,000 from grid plus 1,500 from PV), while the fault current seen by R2 decreases to 6,500 amperes (8,000 from grid minus 1,500 flowing toward the PV plant rather than through R2). When PV output drops to 1.5 MW, R1 sees 8,450 amperes and R2 sees 7,550 amperes. Configuration and parameter manager 522 calculates relay settings such that R1 operates in approximately 0.3 seconds and R2 operates in approximately 0.6 seconds (maintaining the required 0.3 second coordination time interval) across this entire range of fault current variations, typically by computing settings appropriate for the minimum expected fault current scenario to ensure reliable detection while verifying that coordination is maintained at maximum fault current levels.

Coordination parameters calculated at step 710 ensure that actions taken by one edge unit are properly synchronized with actions at other edge units through precise specification of timing and sequencing. For reconfiguration following a fault that requires opening one breaker to isolate the faulted section and closing another breaker to restore service through an alternative feeder, the coordination parameters specify explicit timestamps for synchronized actions (for example, breaker B1 opens at time T=1234567890.100000000, breaker B2 closes at time T=1234567890.150000000, ensuring 50 milliseconds separation to prevent momentary parallel operation), prerequisite conditions that must be satisfied before actions proceed (breaker B2 may only close if voltage measurements confirm that the alternative feeder is energized and within acceptable voltage range), or time delays relative to triggering events (breaker B3 closes 200 milliseconds after successful closure of B2 is confirmed). These coordination parameters enable complex multi-step automation sequences to execute reliably across geographically distributed edge units without requiring real-time communication during the actual switching operations, as all timing is coordinated through the common GPS/PTP time reference and pre-distributed configuration parameters.

Operational logic parameters calculated at step 710 define automation sequence behaviors including load shedding priorities (which loads to disconnect first during under-frequency or under-voltage conditions, typically prioritizing critical loads like hospitals), generation dispatch order (sequence for bringing additional generation online or reducing output), and automatic reconfiguration sequences following faults (which circuit breakers to open and close to restore service through alternative feeders while maintaining proper protection coordination). Coordination parameters ensure actions taken by one edge unit are properly synchronized with actions at other edge units, specifying time delays, prerequisite conditions, or explicit timestamps for synchronized actions.

At step 712, configuration and parameter manager 522 generates configuration packages in lightweight data format, preferably JSON (JavaScript Object Notation), to enable efficient transmission and parsing. Each configuration file includes a unique configuration identifier (enabling version tracking), version number (incremented with each update), timestamp (indicating when the configuration was generated), target edge unit identifier (specifying which edge unit should receive and activate this configuration), and the complete set of parameters organized by functional category (protection parameters grouped together, control parameters in another section, automation logic in a third section, and coordination parameters in a fourth section). A typical configuration file ranges from a few kilobytes to several hundred kilobytes depending on the complexity of the edge unit's functionality and the number of controllable assets and protection zones it manages.

The configuration generation process at step 712 may produce different configuration versions for different edge units simultaneously. When responding to a fault condition detected at edge unit 504A, energy grid optimization computer 502 generates a configuration for 504A with updated protection settings reflecting the isolated fault location, simultaneously generates configurations for 504B and 504C with modified power flow limits to accommodate changed system topology (one line now out of service), and generates a configuration for edge unit 504D (not shown in FIG. 5 but present in the broader system) to prepare for possible load transfer from the affected area. This coordinated multi-unit configuration deployment ensures that all affected portions of the grid adapt simultaneously to maintain system-wide protection coordination and operational optimization.

At step 714, energy grid optimization computer 502 determines whether each affected edge unit is currently connected through network 510. Configuration and parameter manager 522 maintains real-time connection status for all edge units by monitoring heartbeat messages, acknowledging data transmissions, and tracking communication timeouts. If an edge unit is currently unreachable due to network outage, communication infrastructure failure, or edge unit maintenance, configuration and parameter manager 522 identifies this disconnected state.

For edge units determined to be connected at step 714, method 700 proceeds to step 718 where energy grid optimization computer 502 transmits the configuration data package to the edge unit through network 510. The transmission employs secure, error-checked protocols typically using TLS (Transport Layer Security) over TCP/IP to ensure data integrity and prevent unauthorized configuration modifications. The transmission includes the complete configuration file generated at step 712 along with cryptographic signatures enabling the receiving edge unit to verify authenticity and detect any corruption during transmission. For synchronized deployments requiring coordinated activation across multiple edge units, the transmitted configuration includes activation instructions specifying a predetermined timestamp when the new configuration should be applied, enabling nanosecond-level coordination using the GPS/PTP time synchronization capabilities of the edge units.

Following successful transmission at step 716, energy grid optimization computer 502 receives acknowledgment messages from edge units confirming receipt, validation, and activation of new configurations. Configuration and parameter manager 522 updates its configuration inventory tracking which version is now active at each edge unit, enabling accurate system-wide configuration state awareness essential for subsequent optimization calculations and protection coordination verification.

For edge units determined to be disconnected at step 714, method 700 proceeds to step 718 where the configuration is queued for deployment when connectivity is restored. Configuration and parameter manager 522 maintains a deployment queue storing pending configurations for each disconnected edge unit. When communication with a disconnected edge unit is restored (detected through reconnection of heartbeat messages or successful response to polling), configuration and parameter manager 522 automatically initiates transmission of all queued configurations, updating the edge unit to the current system state. This queuing mechanism ensures that temporarily disconnected edge units receive necessary updates without requiring manual operator intervention, maintaining system-wide configuration consistency despite intermittent communication disruptions.

Method 700 returns to step 702 to continue the continuous monitoring and configuration deployment cycle. This iterative process operates throughout system operation, continuously adapting edge unit configurations to maintain optimal protection, control, and automation as grid conditions evolve. The cycle time from trigger event detection to configuration deployment completion typically ranges from seconds to tens of seconds depending on network latency, number of affected edge units, and complexity of required calculations, enabling dynamic adaptation far faster than traditional manual configuration processes that might require hours or days.

FIG. 8 is a flowchart illustrating a method 800 of configuration reception, validation, and activation executed by an edge unit, according to an embodiment of the invention. Method 800 enables edge units to receive and activate new configurations without interrupting time-critical protection and control operations, implementing the “hot update” capability essential for continuous adaptation to changing grid conditions.

At step 802, edge unit 504A receives configuration package and/or software updates through communication interface 602 from energy grid optimization computer 502 via network 510. The reception process monitors incoming data streams for configuration files identified by specific protocol headers or message types. When a configuration transmission begins, communication interface 602 allocates buffer space in temporary memory separate from the active configuration regions, ensuring that ongoing protection and control operations continue uninterrupted using the current configuration while the new configuration is received and validated.

The received data at step 802 may comprise configuration packages (JSON-formatted files containing protection thresholds, control set-points, automation logic parameters, and coordination specifications as described in FIG. 7 step 712), software updates (compiled binary code or firmware images that update embedded edge software with new algorithms, features, or bug fixes), or combined packages containing both configuration data and software components. For software updates, the received files include executable code for protection algorithm 610, control algorithm 614, and automation logic 612 along with version identifiers and digital signatures enabling verification of authenticity and integrity.

At step 804, configuration manager 618 may store the received configuration package and/or software updates in temporary memory regions distinct from the active operational memory. This staging approach prevents any corruption or incomplete reception from affecting ongoing operations. Configuration manager 618 writes the received data to dedicated temporary storage locations, maintaining separation between staged configurations awaiting validation and active configurations currently governing edge unit 504A's protection, control, and automation functions.

At step 806, configuration manager 618 may perform validation checks to ensure the received configuration is complete, compatible, appropriate, and safe for activation. The validation process implements multiple independent checks that must all succeed before configuration activation proceeds.

In an embodiment, integrity validation verifies that the configuration file has not been corrupted during transmission by calculating cryptographic checksums (typically SHA-256 hashes) over the received data and comparing against checksums included in the transmission.

In an embodiment, configuration manager 618 validates data structure consistency by parsing the JSON format and confirming that all required fields are present, all field values conform to specified data types (integers in integer fields, floating-point numbers in floating-point fields, strings in string fields), and the overall structure matches expected schema definitions. Any checksum mismatch or structural inconsistency causes validation failure, triggering error notification transmission and preventing activation of potentially corrupted configuration data.

Compatibility validation confirms that the configuration is appropriate for the specific edge unit by verifying that the target unit identifier in the configuration matches edge unit 504A's assigned identifier (preventing accidental activation of configurations intended for different edge units), that the configuration version is appropriate given edge unit 504A's current software version (ensuring that configuration parameters reference algorithms and features actually present in the installed software), and that all referenced algorithms and functions are available in the unit's embedded edge software (preventing activation of configurations that call non-existent functions). Compatibility validation also checks software dependencies, ensuring that any software updates included in the package are compatible with the hardware architecture and operating system version executing on processor 604.

In an embodiment, range validation may perform a check to determine that all parameter values fall within acceptable operational limits defined by equipment ratings and protection coordination requirements. For relay pickup current settings, range validation confirms values are between defined minimum and maximum thresholds (for example, between 100 amperes and 2000 amperes for a particular protection zone), preventing settings that would either fail to detect faults (too high) or cause nuisance tripping (too low). For voltage set-points, range validation ensures values remain within equipment ratings (typically 0.90 to 1.10 per unit) to prevent damage to connected apparatus. For timing parameters, range validation confirms that coordination time intervals maintain proper sequencing (primary relay must operate at least 300 milliseconds before backup relay) and that time delays fall within reasonable bounds (typically between 0.1 seconds and 10 seconds). Range validation failures indicate potentially erroneous parameter calculations or data corruption, triggering error notification and configuration rejection.

When all validation checks pass successfully at step 806, method 800 proceeds to step 808 where configuration manager 618 performs a rolling update to switch from the old configuration to new configuration without interrupting time-critical operations. The rolling update implements a hot activation mechanism that transitions to the new configuration without requiring processor 604 to reboot, without interrupting the continuous execution cycle of protection algorithm 610, control algorithm 614, and automation logic 612, and without creating any intermediate state where parameters are undefined or inconsistent.

The rolling update at step 808 is implemented as an atomic operation using memory pointer switching. The active configuration and the staged new configuration reside in separate memory regions within configuration storage 620. Configuration manager 618 maintains a single pointer variable that indicates which memory region contains the currently active configuration. At the moment of activation, configuration manager 618 executes a single atomic write instruction that updates this pointer variable to reference the new configuration memory region instead of the old region. This pointer update completes in a single processor instruction cycle (typically less than 100 nanoseconds on modern processors), ensuring true atomic behavior where the system instantaneously transitions from using the old configuration to using the new configuration without any intermediate partial state.

For synchronized updates involving multiple edge units requiring coordinated activation at a specific timestamp, configuration manager 618 monitors the GPS/PTP-synchronized clock provided by time synchronization interface 606 and executes the atomic pointer switch at the precise predetermined time specified in the configuration package. For example, if a configuration specifies activation at absolute time T=1234567890.123456789 (expressed in seconds and nanoseconds since GPS epoch), configuration manager 618 continuously compares the current time from time synchronization interface 606 against the target timestamp and executes the pointer switch when the times match. This mechanism enables multiple edge units distributed across wide geographic areas to simultaneously activate new configurations with nanosecond-level coordination, essential for maintaining protection coordination and system-wide control optimization during configuration transitions.

At step 810, configuration manager 618 evaluates whether the configuration has been activated. In the event that validation fails or activation encounters an error, edge unit 504A, at step 812 retains its previous configuration and transmits an error notification to energy grid optimization computer 502. The error notification includes diagnostic information describing the nature of the validation failure (checksum mismatch, structural error, compatibility issue, or range violation), specific parameter values that failed validation, and the configuration version identifier of the rejected configuration. This detailed error reporting enables configuration and parameter manager 522 to diagnose the problem, correct the configuration generation process if systematic errors are occurring, and retransmit corrected configurations. Edge unit 504A retains its previous stable configuration, ensuring continued protection and control operation despite the configuration update failure.

Following determination of successful rolling update at step 810, method 800 proceeds to step 814 where edge unit 504A transmits activation acknowledgment to energy grid optimization computer 502 through communication interface 602. The acknowledgment message includes the configuration version number now active (enabling configuration and parameter manager 522 to update its system-wide configuration inventory), the activation timestamp (confirming precisely when the new configuration became active, important for correlating configuration changes with operational events), and a success status indicator. This acknowledgment enables energy grid optimization computer 502 to track configuration deployment progress across multiple edge units, verify that coordinated deployments activated successfully at all target locations, and maintain accurate records of configuration history for each edge unit.

At step 816, processor 604 performs sampling of operational parameters and sensor data according to the newly activated configuration. Measurement and I/O control subsystem 622 acquires voltage and current measurements from MV/HV distribution lines 624, generation output data from solar PV plant 626 and wind farm 628, and status signals from circuit breakers, switches, and other field equipment. The sampling occurs at intervals specified in the active configuration, typically every 250 microseconds for continuous analog measurements and upon state change for digital status signals.

Further, at step 816, the sampled data is processed through protection algorithm 610, control algorithm 614, and automation logic 612 according to the parameters specified in the newly activated configuration. Protection algorithm 610 applies the updated threshold settings, time delay parameters, and directional logic to evaluate whether fault conditions exist. Control algorithm 614 uses the updated set-points and control gains to calculate required adjustments to voltage regulators, transformer taps, and capacitor banks. Automation logic 612 executes according to updated sequence definitions and coordination parameters. This continuous processing operates in deterministic cycles with guaranteed completion times, typically 1-5 milliseconds per cycle, ensuring predictable response to faults and disturbances.

At step 817, edge unit 504A may process sampled data through protection and control algorithms and execute autonomous operations. The sampled measurements at step 816 feed into a continuous execution cycle operating deterministically with guaranteed completion times typically ranging from 1 to 5 milliseconds for control operations and even faster for protection functions. This deterministic operation is facilitated by EtherCAT communication protocol connecting processor 604 to measurement and I/O control subsystem 622, providing precise timing guarantees for data acquisition and command output.

Protection algorithm 610 may continuously evaluate the sampled measurements to detect fault conditions by implementing overcurrent detection (comparing measured currents against pickup thresholds defined in configuration storage 620), undervoltage and overvoltage detection (monitoring voltage magnitudes against acceptable limits), frequency deviation detection (tracking system frequency against nominal 60 Hz with typical tolerance of ±0.05 Hz), rate-of-change calculations (detecting rapid changes indicating fault inception or system instability), and directional determination (using voltage and current phase relationships to identify fault direction). The protection logic applies time delays specified by time dial settings in the active configuration and employs inverse-time characteristics where operating time decreases as fault current magnitude increases, appropriate for coordinating with upstream and downstream protection devices.

When protection algorithm 610 detects a fault condition requiring protective action—such as fault current exceeding the pickup threshold for longer than the coordination time delay—edge unit 504A immediately issues trip commands to circuit breakers through measurement and I/O control subsystem 622 digital output channels. These trip commands are executed autonomously without waiting for instructions from energy grid optimization computer 502, ensuring millisecond-level response times essential for limiting equipment damage and preventing fault propagation. The rapid autonomous response is enabled because the protection parameters have been pre-calculated by configuration and parameter manager 522 considering system-wide protection coordination requirements and deployed in the configuration, allowing edge unit 504A to make immediate local decisions while still operating as part of the system-wide protection coordination scheme.

Control algorithm 614 executes voltage regulation, frequency control, and power flow optimization functions according to control set-points specified in configuration storage 620. These algorithms adjust transformer tap changers (changing turns ratio to regulate voltage), switch capacitor banks (modifying reactive power compensation), modify voltage regulator set-points, and control power electronic converter outputs to maintain voltage within acceptable limits (typically 0.95 to 1.05 per unit), regulate reactive power for power factor optimization, and optimize power flows to minimize losses. Control actions are typically less time-critical than protection operations, with update rates ranging from every few AC cycles (100-200 milliseconds for fast voltage regulation) to every few seconds (for slower optimization functions) depending on the control objective.

Coordination with other edge units is achieved through two distinct mechanisms depending on timing requirements. For time-critical coordinated actions requiring nanosecond-level synchronization—such as simultaneous breaker operations across multiple substations for system reconfiguration or synchronized generation adjustments for frequency response—edge unit 504A uses its GPS/PTP-synchronized clock from time synchronization interface 606 to execute actions at predetermined timestamps specified in configuration storage 620. For example, if the configuration specifies that a particular breaker should be closed at absolute time T=1234567890.123456789 (expressed in seconds and nanoseconds since epoch), processor 604 monitors the synchronized clock and executes the closing command through measurement and I/O control subsystem 622 at precisely that instant. This enables multiple geographically distributed edge units to perform coordinated switching operations with nanosecond precision without requiring low-latency real-time communication between units during the actual switching operation, as the coordination is achieved through pre-distributed configuration parameters and common time reference rather than real-time message exchange.

For coordination that does not require nanosecond precision but does require information exchange between edge units—such as load balancing decisions requiring knowledge of generation and load conditions across multiple regions—coordination may be mediated through energy grid optimization computer 502. Edge unit 504A detecting a condition requiring coordinated response (such as generation capacity reduction or load increase approaching thermal limits) reports the condition to energy grid optimization computer 502 through communication interface 602, which then calculates appropriate responses for multiple edge units and deploys updated configurations containing the necessary coordination parameters to all affected units.

Concurrent with executing protection and control operations, edge unit 504A continuously collects operational data characterizing the state and performance of its supervised portion of the energy grid. This data collection serves multiple purposes including local decision-making by protection algorithm 610 and control algorithm 614, transmission to energy grid optimization computer 502 for system-wide analysis by analyzer 512, and local storage in edge memory 608 for forensic analysis following disturbances. Collected data includes measurement data (instantaneous voltage and current values, calculated quantities such as real power, reactive power, apparent power, power factor, and frequency derived from high-speed sensor sampling with additional processing to calculate RMS values, average values over time windows, and statistical properties), event data (fault detections, protection device operations such as breaker trips or closures, alarm conditions, communication status changes, and configuration updates, each timestamped using time synchronization interface 606 for precise correlation across multiple edge units), status data (current operating state of all supervised equipment including breaker positions, switch positions, regulator tap positions, capacitor bank status), and performance metrics (response time to faults, voltage regulation accuracy, frequency of control actions).

To reduce communication bandwidth requirements and avoid overwhelming energy grid optimization computer 502 with raw data, communication interface 602 performs filtering and aggregation of collected measurements before transmission at step 818. Change-based filtering transmits new measurements only when values change by more than a predetermined threshold (for example, voltage transmitted only when it changes by more than 0.5% from previously reported value), avoiding redundant transmission of steady-state values. Periodic updates are transmitted even during steady-state operation at intervals ranging from seconds to minutes to confirm continued operation. Event-triggered transmission immediately sends high-priority data when significant events occur—fault detections, protection operations, and alarm conditions trigger immediate transmission of associated measurements and event details enabling rapid system-wide response. Aggregation combines multiple measurements into summary statistics transmitted over longer time windows; instead of transmitting individual voltage measurements every 250 microseconds, communication interface 602 might transmit average voltage, minimum voltage, and maximum voltage observed over each one-second interval, preserving information about voltage variation while drastically reducing data volume.

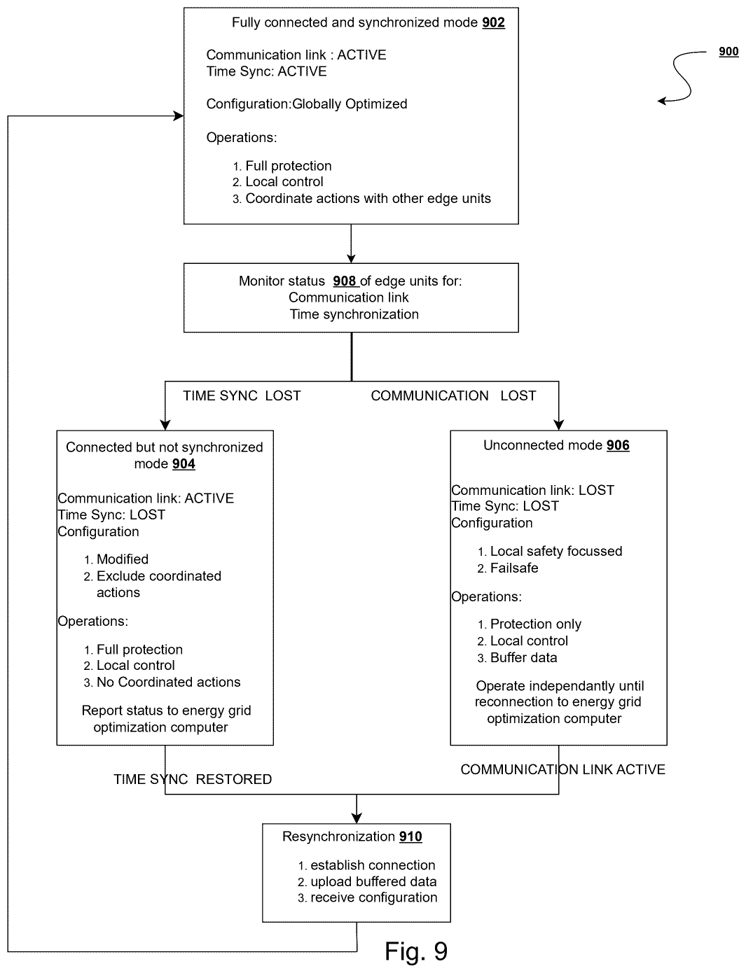

The filtered and aggregated data is buffered in edge memory 608 if communication with energy grid optimization computer 502 is temporarily unavailable. The buffer accumulates data for later transmission when connectivity is restored, preventing data loss during communication outages. Buffer size is designed to accommodate typical outage durations ranging from minutes to hours, with the buffered data uploaded during resynchronization (described in FIG. 9)

At step 818, communication interface 602 transmits sampled data to energy grid optimization computer 502 through network 510. The transmitted data undergoes filtering by communication interface 602 to reduce bandwidth requirements while ensuring that all relevant information reaches energy grid optimization computer 502. Change-based filtering transmits new measurements only when values change by more than predetermined thresholds (for example, transmitting voltage only when it changes by more than 0.5% from the previously reported value), avoiding redundant transmission of steady-state values. Periodic updates are transmitted at regular intervals (ranging from seconds to minutes) even during steady-state operation to confirm continued operation and provide timestamps for correlation with other system events. Event-triggered transmission immediately sends high-priority data when significant events occur, including fault detections (transmitted with highest priority within milliseconds of detection), protection device operations (breaker trips or closures reported immediately), alarm conditions (equipment failures, communication losses, or operational limit violations sent as soon as detected), and mode transitions (changes between connected/unconnected or synced/not-synced states reported immediately for system-wide awareness).

Method 800 returns to step 802 to continue monitoring for new configuration packages and software updates while simultaneously continuing the sampling and data transmission cycle through steps 816 and 818. This creates a continuous operational loop where edge unit 504A maintains ongoing protection, control, and automation execution while remaining ready to receive and activate new configurations as system conditions evolve. The method operates throughout edge unit 504A's service life, enabling dynamic adaptation without service interruptions or manual intervention.

The deployment process described in method 800 operates continuously as a background function, with new configurations generated and deployed as frequently as every few seconds to every few minutes depending on the rate of change in system conditions. During periods of stable operation, deployment frequency may be reduced, while during disturbances or rapid changes in renewable generation, deployment frequency increases.

FIG. 9 is a state diagram illustrating the three primary operating modes of edge units according to an embodiment of the invention. This state diagram depicts the resilience mechanisms that enable edge units to maintain grid protection and control during communication failures and time synchronization losses while automatically returning to optimal operation when conditions are restored.

In an embodiment, a fully connected and synchronized mode 902 represents an optimal operating state where edge unit 504A maintains active communication link through network 510 with energy grid optimization computer 502 and maintains nanosecond-level time synchronization through time synchronization interface 606 with other edge units.

In this mode, edge unit 504A may operate according to globally optimized configuration parameters calculated by optimizer 508 considering system-wide conditions, generation and load patterns across all managed regions, optimal power flows minimizing system losses, and coordinated protection schemes ensuring proper relay coordination throughout the network.

During fully connected and synchronized mode 902, edge unit 504A may perform full protection by executing protection algorithm 610 to detect and isolate faults within its protection zones with millisecond-level response times. A local control is implemented through control algorithm 614 adjusting voltage regulators, transformer taps, and reactive power compensation devices according to system-wide optimization objectives. Edge unit 504A executes coordinated actions with other edge units using precise timestamps from time synchronization interface 606 to perform synchronized breaker operations, implement system-wide frequency response strategies, and coordinate automatic reconfiguration sequences following faults. The coordinated actions capability enabled by nanosecond-level time synchronization allows edge unit 504A to participate in sophisticated control schemes where, for example, multiple edge units simultaneously adjust generation output or load consumption to arrest frequency deviations, or where sequential breaker operations across different substations restore service through alternative feeders with precisely timed switching to prevent momentary parallel operation or voltage transients.

In an embodiment, mode manager 616 may continuously monitors status 908 of edge units, tracking two critical operational parameters: communication link status with energy grid optimization computer 502 and time synchronization status relative to GPS/PTP reference and other edge units.

In an embodiment, communication link status may be evaluated by monitoring heartbeat messages (periodic keep-alive signals transmitted between edge unit 504A and energy grid optimization computer 502, typically every few seconds), successful data transmission acknowledgments (confirming that operational data transmitted from edge unit 504A reaches energy grid optimization computer 502 and that configuration files transmitted from energy grid optimization computer 502 reach edge unit 504A), and communication timeout detection (identifying when expected messages fail to arrive within predetermined time windows, typically 500 milliseconds for heartbeat timeouts).

In an embodiment, time synchronization status may be evaluated by comparing edge unit 504A's local clock against GPS absolute time reference provided by time synchronization interface 606, measuring clock drift relative to PTP master clocks in the synchronization hierarchy, and calculating synchronization error magnitude to determine whether timing accuracy remains within acceptable bounds (typically ±10 microseconds or better for coordinated protection applications, ±1 microsecond or better for synchrophasor measurements). Time synchronization interface 606 continuously reports synchronization quality metrics to mode manager 616, enabling real-time assessment of timing accuracy and reliability.

During evaluation of communication link status and time synchronization status, when mode manager 616 detects time synchronization loss while communication link remains active, indicated by synchronization error exceeding the acceptable threshold or loss of GPS satellite lock combined with PTP master clock unreachability, edge unit 504A transitions from “fully connected and synchronized mode” 902 to “connected but not synchronized mode” 904. This transition occurs automatically without requiring operator intervention or confirmation from energy grid optimization computer 502, and a fail-safe behavior is implemented that prevents edge unit 504A from attempting coordinated actions with other edge units when precise timing cannot be guaranteed.

In an embodiment, connected but not synchronized mode 904 represents a degraded but functional operating state where edge unit 504A maintains communication with energy grid optimization computer 502 (enabling continued reception of configuration updates and transmission of operational data) but has lost time synchronization capability (preventing participation in coordinated actions requiring nanosecond-level timing precision).

In an embodiment, configuration manager 618 may activate a modified configuration tailored for operation without time synchronization, which excludes coordinated actions requiring precise timing synchronization across multiple edge units, such as synchronized generation ramping for frequency response, coordinated breaker switching for system reconfiguration, and synchrophasor-based protection schemes relying on time-aligned measurements from multiple locations.

Despite the loss of time synchronization, connected but not synchronized mode 904 maintains full local protection functions through protection algorithm 610 detecting and clearing faults within edge unit 504A's protection zones using locally-measured quantities and local timing references, continues local control operations through control algorithm 614 regulating voltage and reactive power based on measurements from measurement and I/O control subsystem 622, and preserves communication with energy grid optimization computer 502 enabling continued system monitoring and configuration updates.

The modified configuration activated during connected but not synchronized mode 904 may adjust protection settings to account for reduced coordination capability, potentially employing more conservative thresholds or longer time delays to ensure security (avoiding false trips) even if slightly compromising dependability (possibly slower fault clearing in certain scenarios).

In an embodiment, edge unit 504A may report its mode transition to energy grid optimization computer 502 immediately upon entering connected but not synchronized mode 904, enabling analyzer 512 to account for edge unit 504A's reduced capabilities in system-wide optimization calculations. Energy grid optimization computer 502 may deploy modified configurations to other edge units to compensate for edge unit 504A's inability to participate in coordinated actions, redistributing frequency response responsibilities to other edge units with functioning time synchronization or adjusting protection coordination schemes to account for edge unit 504A operating with modified settings.

During evaluation of communication link status and time synchronization status, when mode manager 616 detects communication link loss, indicated by heartbeat message timeouts exceeding predetermined thresholds (typically 500 milliseconds), repeated data transmission failures despite retry attempts, or complete loss of network 510 connectivity, edge unit 504A may transition from either fully connected and synchronized mode 902 or connected but not synchronized mode 904 to unconnected mode 906. This transition implements the highest level of autonomous fail-safe operation, recognizing that edge unit 504A can no longer receive updated configurations or coordination instructions from energy grid optimization computer 502.

In an embodiment, unconnected mode 906 represents fully autonomous operation where edge unit 504A prioritizes safety over optimization, focusing on maintaining protection of equipment and personnel within its local region rather than attempting system-wide coordination or optimization.

In the unconnected mode 906, configuration manager 618 may activate a local safety-focused failsafe configuration that has been pre-loaded during connected operation specifically for use during communication outages. This failsafe configuration emphasizes conservative protection settings with reduced pickup thresholds and shorter time delays, ensuring faults are detected and cleared even if this results in slightly increased nuisance trip risk, implements reduced or disabled control functions that might destabilize the local system without visibility into system-wide conditions, and activates operational restrictions such as limiting voltage regulator adjustments to narrow ranges, disabling automatic reconfiguration sequences that require coordination with other edge units, and preventing actions that would significantly alter power flows potentially affecting other regions.

During unconnected mode 906, protection algorithm 610 continues executing fault detection and isolation protecting edge unit 504A's supervised equipment from damage due to short-circuit faults, overcurrent conditions, undervoltage and overvoltage excursions, and frequency deviations. Local control through control algorithm 614 maintains limited regulation focusing on keeping local voltage within acceptable limits and maintaining local power quality without attempting system-wide optimization that requires information from other regions. Edge unit 504A buffers operational data in local storage provided by edge memory 608, accumulating measurements, event logs, and status reports that cannot be transmitted due to communication loss but will be uploaded during resynchronization 910 when connectivity is restored.

The buffering capability during unconnected mode 906 ensures no operational data is permanently lost during communication outages, enabling complete forensic reconstruction of system behavior during the disconnected period. Buffer size in edge memory 608 is designed to accommodate typical communication outage durations ranging from minutes to hours, with older data being overwritten by newer data if buffer capacity is exceeded during extended outages.

During operation, when mode manager 616 detects restoration of communication link with energy grid optimization computer 502 and restoration of time synchronization, edge unit 504A initiates resynchronization 910 protocol returning to fully connected and synchronized mode 902. Resynchronization 910 comprises multiple sequential steps ensuring edge unit 504A returns to optimal operation with accurate configuration and complete data transfer.

In an embodiment, resynchronization 910 process may begin by establishing connection through communication interface 602 verifying bidirectional communication with energy grid optimization computer 502 through successful exchange of authentication credentials and handshake messages. Following communication establishment, edge unit 504A uploads buffered data accumulated during unconnected mode 906 or connected but not synchronized mode 904, transmitting stored measurements, event logs describing faults detected and actions taken during the disconnected period, status reports documenting equipment operations and mode transitions, and performance metrics characterizing edge unit 504A's operational behavior during degraded modes. This data upload enables energy grid optimization computer 502 to reconstruct complete system operational history despite the communication interruption and to evaluate whether any significant events occurred requiring operator attention or configuration adjustments.

In an embodiment, concurrently with or immediately following buffered data upload, edge unit 504A receives updated configuration from energy grid optimization computer 502 through the standard configuration deployment process described in FIGS. 7 and 8. This updated configuration accounts for any system changes that occurred during edge unit 504A's disconnected period, including topology modifications (new generation sources connected, loads disconnected, line outages), capacity changes (renewable generation output variations, load demand shifts), or protection coordination adjustments (changes in other edge units' settings necessitating corresponding adjustments in edge unit 504A's parameters). Configuration manager 618 validates and activates the received configuration using the atomic rolling update mechanism described in FIG. 8, ensuring smooth transition to current system-wide optimized operation.

Time synchronization interface 606 re-establishes precise timing reference by reacquiring GPS satellite signals (if GPS was the source of synchronization loss) or resynchronizing with PTP master clocks (if network-based timing was disrupted). Mode manager 616 verifies that time synchronization error has returned below acceptable thresholds (typically ±10 microseconds) before declaring full synchronization restoration. Upon confirming both communication restoration and time synchronization restoration, mode manager 616 transitions edge unit 504A back to fully connected and synchronized mode 902, restoring full operational capability including coordinated actions with other edge units.

The automatic mode transitions and resynchronization mechanisms depicted in FIG. 9 ensure that edge unit 504A maintains continuous protection and control throughout all operational conditions: optimal during normal operation with full communication and synchronization, degraded but safe during partial connectivity or synchronization loss, and autonomous safety-focused during complete communication failure until returning to optimal operation when conditions permit. This resilience architecture enables the hybrid intelligence framework to maintain grid safety and reliability despite communication infrastructure failures while maximizing optimization benefits during normal operation.

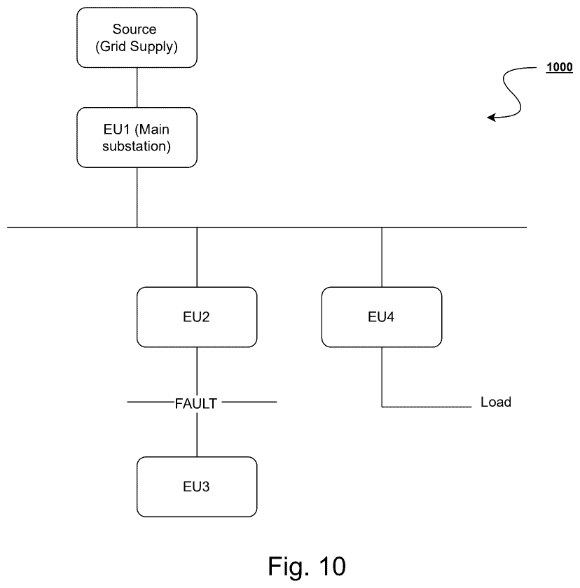

FIG. 10 is a single-line diagram illustrating an exemplary distribution network topology with four edge units managing different geographical regions, according to an embodiment of the invention. FIG. 10 illustrates an exemplary scenario 1000 demonstrating the operation of the hybrid intelligence architecture during a fault event with subsequent self-healing reconfiguration. The example involves a distribution grid with four edge units (EU1-EU4) where EU1 serves as the main substation, EU2 and EU4 are regional distribution substations, and EU3 supplies a load area with an integrated 5 MW solar photovoltaic installation.

At time T=0, a three-phase fault occurs on the distribution feeder between EU2 and EU3, simulating a tree contact or similar mechanical fault. Within 0.25 milliseconds, EU2's measurement units detect the fault through voltage and current sampling at 250 microsecond intervals, observing fault current of approximately 8,500 amperes and voltage collapse to 0.15 per unit.

EU2's embedded protection algorithms compare the measured fault current against protection parameters in its active configuration, which specify a pickup threshold of 1,200 amperes, a 300-millisecond time delay, and forward directional logic. The algorithms confirm that the fault current exceeds the pickup threshold, flows in the forward direction toward EU3, and persists beyond the coordination time delay.

Critically, the other edge units in the system correctly refrain from tripping despite detecting the disturbance. EU1 detects the fault current but recognizes the fault as downstream in EU2's protection zone and waits to provide backup protection only if EU2 fails to operate. EU3 detects voltage collapse and reverse current from its local solar generation but correctly identifies the fault as upstream and does not trip. EU4 on a parallel feeder detects only minor voltage depression and continues normal operation. This selective response is achieved because each edge unit's configuration was generated by energy grid optimization computer 502 with system-wide knowledge of the network topology, ensuring proper coordination despite the complex multi-unit configuration.

At T=350 milliseconds, EU2 issues a trip command to its circuit breaker, successfully isolating the faulted line section. EU2 immediately transmits a fault event report to energy grid optimization computer 502 including fault location, magnitude, duration, and breaker status. The isolation is achieved through autonomous edge operation without requiring communication with or approval from energy grid optimization computer 502, enabling the rapid millisecond-level response essential for equipment protection.

Within 500 milliseconds of receiving the fault report, energy grid optimization computer 502 analyzes the system-wide impact of the topology change. The analysis determines that EU3's load area is now isolated, the 5 MW solar generation is offline, and the system has a net 2 MW generation deficit. Energy grid optimization computer 502 evaluates restoration options and determines that a self-healing configuration can restore service to EU3's loads by routing power through EU4 via a normally-open tie breaker.

Energy grid optimization computer 502 generates new configuration packages for EU1, EU3, and EU4. EU4's configuration includes instructions to close its tie breaker and updated protection parameters accounting for the new power flow pattern. EU3's configuration adapts its protection for receiving power from EU4 instead of EU2. EU1's configuration adjusts generation dispatch to compensate for the lost solar capacity. These configurations are deployed to the respective edge units within 2 seconds of the fault event.

At T=3 seconds, the edge units execute the self-healing sequence. EU4 closes its tie breaker, establishing an alternate supply path to EU3's load area. Power flow is restored, and the system reaches a new stable operating state with the faulted section isolated and service restored to all loads except those directly on the faulted line segment. The entire sequence from fault occurrence to load restoration completes in 3 seconds without manual intervention, demonstrating the autonomous adaptation capability enabled by the continuous configuration update methodology.

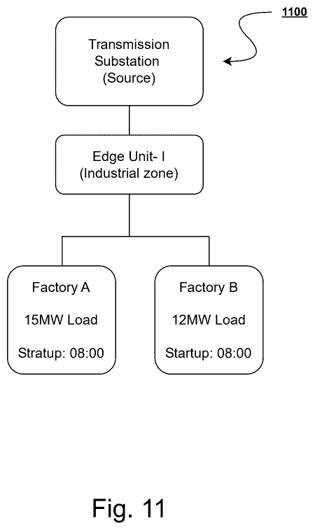

FIG. 11 is a single-line diagram illustrating a transmission substation supplying an industrial zone with multiple factory loads, according to an embodiment of the invention. FIG. 11 illustrates an exemplary scenario 1100 demonstrating predictive voltage regulation in response to recurring daily load patterns. The example involves edge unit I (EU-I) serving an industrial zone containing multiple manufacturing facilities that follow predictable startup schedules.

Energy grid optimization computer 502 may maintain historical operational data showing that factories in EU-I's service area consistently begin operations at 08:00 on weekdays. Analysis of this pattern, accumulated over months of operation, reveals that factory startup creates a significant reactive power demand surge of approximately 5 MVAR as motors, transformers, and other inductive loads energize simultaneously. This reactive power demand historically causes voltage to drop from 1.00 per unit to 0.94 per unit, below the acceptable minimum of 0.95 per unit, and increases I²R losses on transmission lines supplying the industrial zone.

At 07:55, five minutes before the predicted event, energy grid optimization computer 502 may generate a new configuration for EU-I and deploy it through communication network 510. The configuration contains parameters scheduled for activation at precisely 08:00:00.000 GPS time, including activation of the reactive power compensation algorithm and a target voltage set-point of 1.02 per unit. The configuration specifies that the capacitor bank should be switched online and the voltage regulator should adjust its tap position to the calculated optimal setting.

EU-I may receive the configuration at 07:55, validates its integrity and compatibility, and stage it in memory without interrupting ongoing protection and control operations. At exactly 08:00:00.000, synchronized to GPS time, EU-I executes a hot update to activate the new configuration. The capacitor bank is energized and the voltage regulator adjusts its tap position in the moments immediately preceding factory startup.

When the factories energize their equipment at 08:00, the reactive power compensation is already active. The capacitor bank supplies the required 5 MVAR of reactive power locally, and the voltage regulator maintains the target 1.02 per unit voltage. As a result, the grid voltage remains stable within acceptable limits throughout the startup event. Because the reactive power is supplied locally rather than drawn through transmission lines, I²R losses are minimized. Traditional systems would have detected the voltage drop after it occurred and responded reactively, resulting in several minutes of low voltage conditions and elevated losses.

Following the event, EU-I transmits performance data to energy grid optimization computer 502, including measured voltage profile, reactive power flow, and timing accuracy. Energy grid optimization computer 502 validates that the prediction and proactive response were successful, and the AI forecasting model of analyzer 512 incorporates this additional data point to refine future predictions. The configuration remains active throughout the factory operating day and is automatically adjusted for factory shutdown periods based on the learned operational pattern.

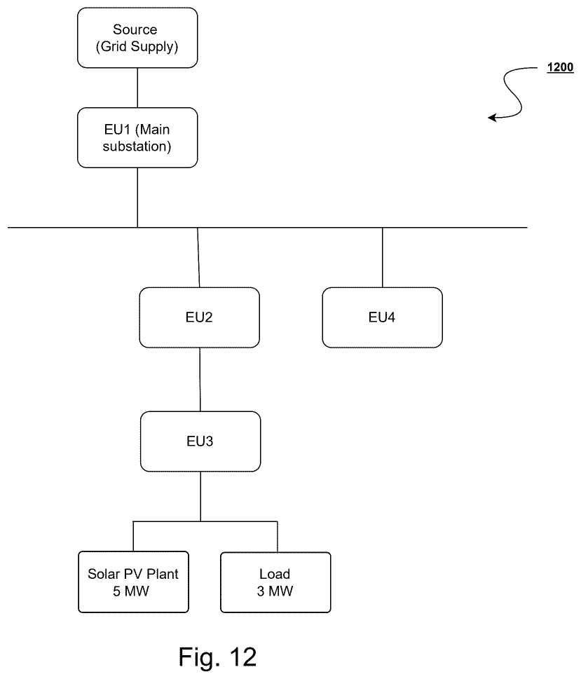

FIG. 12 is a single-line diagram illustrating a distribution network with integrated solar photovoltaic generation, according to an embodiment of the invention. FIG. 12 illustrates an exemplary scenario 1200 demonstrating adaptive protection coordination in response to variable renewable energy generation. The example involves a 5 MW solar photovoltaic (PV) plant connected at edge unit 3 (EU3), with primary protection provided by edge unit 2 (EU2) and backup protection at edge unit 1 (EU1).

Under normal sunny conditions at T=0, the solar plant generates 5 MW while local load consumes 3 MW, resulting in 2 MW net export to the grid through EU2. The protection system is configured with relay pickup settings and time delays calculated for fault current contributions from both the grid and the solar plant. For a three-phase fault on the line between EU2 and EU3, the grid contributes approximately 8,000 amperes while the solar plant contributes approximately 1,500 amperes, for a total of 9,500 amperes at EU2. The protection settings ensure proper coordination with a 300-millisecond coordination time interval between primary relay EU2 and backup relay EU1.

At T=10 minutes, energy grid optimization computer 502 may detect declining solar output as a large cloud bank approaches the solar farm. Real-time monitoring data shows output declining from 5 MW to 3.5 MW at a rate of 0.5 MW per minute. Energy grid optimization computer 502 may integrates weather forecast data and satellite imagery confirming cloud coverage, and apply AI forecasting models trained on historical cloud cover events to predict the solar output will drop to approximately 1.5 MW within five minutes, representing a 70% reduction from full capacity.

Energy grid optimization computer 502 may immediately analyze the protection coordination implications of this capacity change. Because fault current contribution from the solar plant is proportional to its output level, the predicted reduction from 5 MW to 1.5 MW will reduce the solar plant's fault current contribution from 1,500 amperes to approximately 450 amperes. The total fault current at EU2 will decrease from 9,500 amperes to 8,450 amperes. With the existing protection settings, this reduced fault current will cause EU2's operating time to increase slightly while EU1's operating time remains constant, potentially resulting in the backup relay operating before the primary relay and causing unnecessary widespread outages.

Within three seconds of detecting the trigger condition, energy grid optimization computer 502 may calculate new protection settings using an adaptive protection algorithm that applies a dynamic adjustment factor to maintain proper coordination despite the variable fault current levels. The new configuration for EU2 reduces the pickup current threshold from 1,200 to 1,050 amperes and adjusts the time delay from 0.30 to 0.28 seconds. The backup protection at EU1 is similarly adjusted. These new settings ensure that EU2 will operate in 0.28 seconds and EU1 in 0.58 seconds for the reduced fault current scenario, maintaining the required 300 millisecond coordination time interval.

The configuration packages are deployed to EU2 and EU1 within five seconds of the initial detection. Each edge unit receives the configuration, validates it, and executes a hot update to activate the new protection parameters without interrupting ongoing protection functions. The configuration switch completes while fault monitoring continues uninterrupted, ensuring the grid remains protected throughout the transition.

When the solar output reaches its minimum of 1.5 MW at T=15 minutes, the adaptive protection settings are already active. If a fault were to occur at this moment, EU2 would correctly operate as the primary protection device in 0.28 seconds, while EU1 would wait as backup, demonstrating that coordination is maintained despite the 70% reduction in solar generation. As the cloud passes and solar output begins recovering at T=30 minutes, energy grid optimization computer 502 detects the capacity increase and repeats the adaptation process, generating and deploying updated configurations appropriate for the higher generation level. This continuous adaptation cycle ensures proper protection coordination is maintained throughout the dynamic fluctuation's characteristic of renewable energy sources.

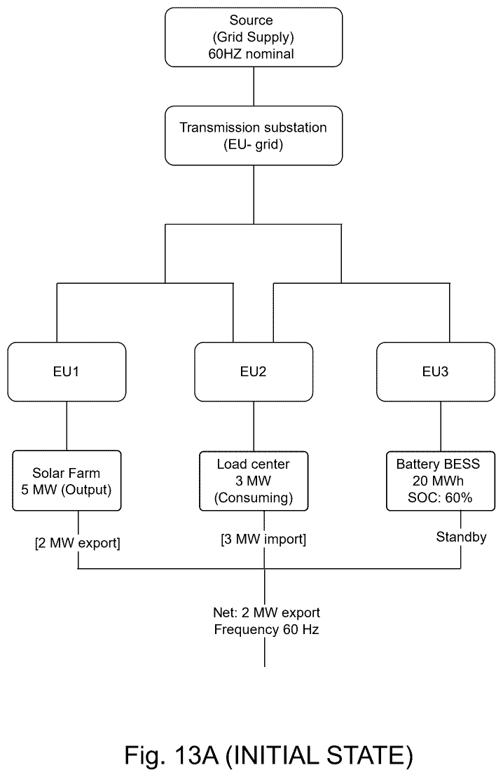

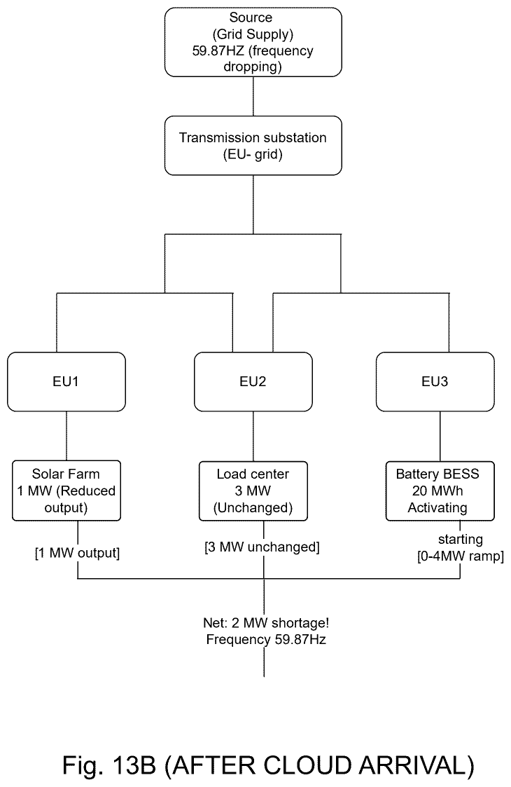

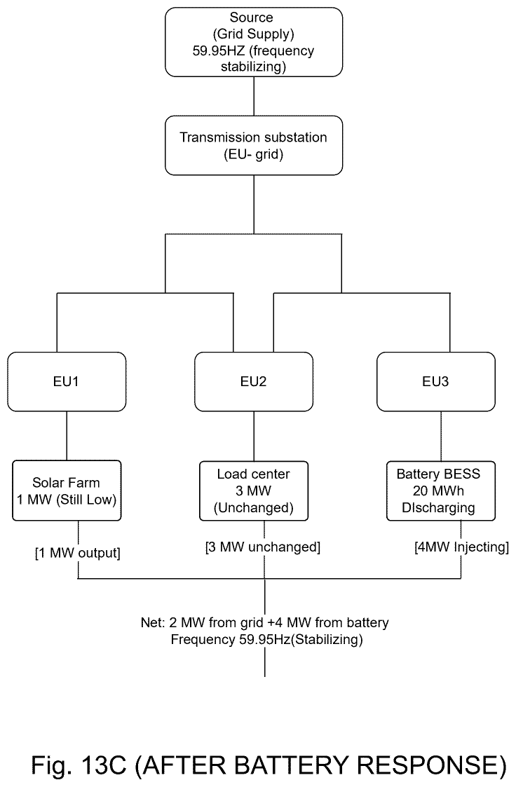

FIGS. 13A-13C are sequential single-line diagrams illustrating a temporal progression of fast frequency response to sudden solar generation loss, according to an embodiment of the invention.

Modern grids with high renewable penetration face a critical challenge where sudden generation drops due to weather events create immediate power imbalances that threaten system frequency stability. Cloud coverage over solar farms or wind lulls can cause renewable output to drop precipitously within seconds. Unlike traditional controllable generators with inherent rotating inertia, renewable sources provide no mechanical inertia, requiring extremely fast compensatory response to prevent frequency collapse and cascading outages.

The scenario illustrates in FIGS. 13A, 13B and 13C demonstrates how the adaptive smart grid management system addresses this challenge through coordinated response between energy grid optimization computer 502 and distributed autonomous edge units. The grid configuration comprises three edge units: EU-1 manages a 5 MW solar photovoltaic farm, EU-2 manages a 3 MW load center, and EU-3 manages a 20 MWh battery energy storage system (BESS) operating at 60% state of charge.

At time T=0 (depicted by FIG. 13A), the system operates in a normal steady state with the solar farm generating 5 MW and the load center consuming 3 MW, resulting in a 2 MW net export to the grid. The system frequency remains stable at the nominal value of 60.00 Hz, with all edge units operating in their connected and synchronized mode, continuously streaming operational data to energy grid optimization computer 502.

At T=2 seconds (depicted by FIG. 13B), a large cloud bank suddenly covers the solar farm, causing the solar output to drop from 5 MW to 1 MW within seconds—an 80% reduction representing a 4 MW generation loss. The measurement and input/output units at EU-1, sampling at 250 microsecond intervals, immediately detect this rapid change in generation. EU-1's embedded edge software recognizes this as a generation drop event (not a fault requiring protection action) and streams high-priority data to energy grid optimization computer 502, including the current solar output, rate of change, and precise timestamp.

Energy grid optimization computer 502 receives this alert at T=2.5 seconds and performs immediate system-wide analysis with a processing time of approximately 50 milliseconds. The analysis calculates that the sudden 4 MW deficit will create a critical power imbalance in the system. Using its predictive models that account for system inertia and load characteristics, analyzer 512 predicts that the frequency will drop from 60.00 Hz to approximately 59.85 Hz within 2-3 seconds if no corrective action is taken. This predicted frequency level approaches the critical threshold of 59.80 Hz that would automatically trigger emergency load shedding, potentially causing widespread customer outages.

Based on this analysis, energy grid optimization computer 502 at T=2.6 seconds determines that fast frequency response is required and evaluates available resources to provide this response. The optimization algorithm considers three options: increasing grid import (response time approximately 30 seconds—too slow), activating the battery system (response time under 2 seconds), or implementing load shedding (undesirable customer impact). The battery system at EU-3 is selected as the optimal resource due to its sub-second response capability and available capacity. A configuration package is generated specifying the operational parameters: discharge mode set to “fast_frequency_response”, target power output of 4.0 MW, aggressive ramp rate of 2.5 MW per second to reach target quickly, and frequency droop control enabled with a 4% droop coefficient to provide continuous frequency-responsive adjustment.

Between T=2.7 and T=2.8 seconds, this configuration package is deployed to EU-3. The package, formatted as a lightweight JSON file requiring approximately 100 milliseconds for transmission over the communication network, arrives at EU-3 where the edge unit's embedded software performs validation checks. The validation process confirms that the battery state of charge is sufficient (60% exceeds the 20% minimum threshold), the requested discharge rate is within equipment limits (4.0 MW is below the 5.0 MW maximum), and the battery temperature is within acceptable operating range. Upon successful validation, EU-3 performs a hot activation of the new configuration, switching from standby mode to fast frequency response mode without interrupting any ongoing monitoring operations. The edge unit sends an acknowledgment back to energy grid optimization computer 502 confirming that the configuration has been activated and battery discharge is commencing.

From T=3.0 to T=4.6 seconds, EU-3 executes the fast frequency response through its battery inverter control algorithm. The edge unit's processor, operating autonomously based on the deployed configuration, commands the battery inverter to begin ramping discharge power. At T=3.0 seconds, the ramp initiates from 0 MW. By T=3.2 seconds, output reaches 0.5 MW as the system frequency continues declining to 59.89 Hz. At T=3.5 seconds, with battery output at 1.25 MW, the system frequency reaches its nadir (lowest point) of 59.85 Hz—precisely as predicted by energy grid optimization computer 502. As the battery continues ramping, the frequency begins recovering: at T=3.8 seconds, with 2.0 MW battery output, frequency improves to 59.87 Hz. By T=4.2 seconds, battery output reaches 3.0 MW and frequency recovers to 59.91 Hz. Finally, at T=4.6 seconds, the battery reaches its target output of 4.0 MW and the system frequency stabilizes at 59.95 Hz. Throughout this rapid response, the embedded frequency droop control algorithm continuously adjusts the output based on real-time frequency measurements, providing natural stabilization without requiring additional instructions from energy grid optimization computer 502.

Between T=5 and T=10 seconds (depicted by FIG. 13C), the system transitions from primary frequency response to secondary control and full frequency restoration. With the immediate frequency crisis averted, energy grid optimization computer 502, activates the Automatic Generation Control (AGC) function to coordinate longer-term system rebalancing. The AGC gradually increases generation from grid sources while preparing to ramp down the battery discharge to preserve battery capacity for future events. By T=10 seconds, the system achieves full frequency restoration to the nominal 60.00 Hz, with the battery output reduced to a sustained 3.0 MW discharge level that continues to compensate for the still-reduced solar generation while clouds remain over the solar farm.

This scenario demonstrates several key innovations of the hybrid intelligence architecture. First, autonomous edge execution for time-critical control enables EU-3 to execute millisecond-level battery inverter control without requiring real-time approval from energy grid optimization computer 502, for each control action, achieving the sub-second response speed essential for frequency stability. Second, the system achieves centralized optimization with distributed execution, where energy grid optimization computer 502 performs system-wide analysis and optimal resource selection, but the actual execution occurs autonomously at the edge through deployed configurations, combining the benefits of global optimization with local execution speed. Third, dynamic configuration deployment enables the system to respond within 800 milliseconds from detection to activation. A configuration package is generated, transmitted, validated, and activated orders of magnitude faster than any manual intervention. Fourth, the integration of sophisticated control algorithms such as frequency droop control within the deployed configuration enables the battery inverter to continuously adjust output based on real-time frequency measurements, providing natural frequency stabilization. Fifth, the system demonstrates robust bi-directional power flow management, seamlessly transitioning from a state where EU-1 exports power (when solar generation exceeds local load) to a state where EU-3 injects power (battery compensating for solar deficit).

The contrast with traditional static control systems highlights the critical advantages of the adaptive approach. A traditional system would require manual operator detection of the generation drop event, typically taking several minutes as operators analyze SCADA displays and alarm systems. Manual calculation of the required response would take additional minutes, followed by manual dispatch of battery or other resources through voice communication or manual SCADA commands. The static control parameters in traditional systems cannot adapt to the specific characteristics of each event, such as the rate of generation change or the precise magnitude of the deficit. The total response time for traditional systems typically ranges from 5 to 15 minutes—far too slow to prevent frequency collapse when generation drops occur within seconds. By contrast, the adaptive system responds in under 3 seconds through automatic detection in milliseconds, autonomous analysis and optimization in 50 milliseconds, dynamic configuration deployment in 200 milliseconds, and coordinated fast frequency response achieving full power output in 1.6 seconds.

It is important to distinguish this Example 3 (power balance and frequency control) from Example 5 (adaptive protection for relay coordination). While both examples may be triggered by the same physical event—cloud coverage reducing solar output—they address fundamentally different technical challenges in different

The skilled person will be aware of a range of possible modifications of the various embodiments described above. Accordingly, the present invention is defined by the claims and their equivalents.

What is claimed is:

1. A system for energy grid management, the system comprising:
an energy grid optimization computer comprising a processor, a memory, and a plurality of programming instructions, the plurality of programming instructions when executed by the processor cause the processor to:
receive operational data from a plurality of edge units distributed throughout an energy distribution network;
continuously monitor the received operational data to detect trigger events, wherein the trigger events comprise at least one of renewable generation fluctuations exceeding a predetermined threshold, predicted grid congestion, fault conditions requiring protection scheme adjustments, connection or disconnection of generation or load assets, or forecasted weather events affecting line capacity or renewable output;
responsive to detecting a trigger event,
perform system-wide analysis to identify affected edge units requiring configuration updates;
calculate updated parameters for the identified affected edge units to account for variable fault current contributions from renewable sources, wherein the updated parameters account for at least one of: variable fault current contributions from renewable sources, voltage regulation requirements, power flow optimization, load balancing needs, or protection coordination adjustments;
generate configuration packages for each of the identified affected edge units in a lightweight data format, wherein each configuration package is tailored to a specific edge unit and comprises parameters specific to that edge unit's supervised assets, protection zones, and operational requirements;
transmit respective configuration packages to the affected edge units through a communication network, wherein each of the affected edge unit receives, validates, and activates the respective configuration package to enable autonomous execution of protection and control operations while streaming filtered operational data to the energy grid optimization computer.

2. The system of claim 1, wherein to perform system-wide analysis to identify affected edge units, the plurality of programming instructions when executed by the processor cause the processor to:
processes, using an analyzer, incoming data streams from all edge units to perform system-wide state analysis;
utilize, optimizer, to implement algorithms to predict future conditions;
generate, using a configuration and parameter manager, configuration files for the affected edge units based on current system state, the future conditions, and optimization results.

3. The system of claim 1, wherein the lightweight data format comprises JSON format, and wherein each configuration package includes a unique configuration identifier, version number, timestamp, and target edge unit identifier.

4. The system of claim 1, wherein to transmit respective configuration packages, the plurality of programming instructions causes the processor to:
determine whether each affected edge unit is connected through the communication network;
for the connected edge units, transmit the configuration package using secure communication protocols; and
for disconnected edge units, queue the configuration package for transmission upon restoration of connectivity.

5. A system for distributed energy grid management, the system comprising:
a plurality of edge units distributed throughout an energy distribution network, each edge unit comprising:
a communication interface configured to receive configuration packages from an energy grid optimization computer and transmit operational data to the energy grid optimization computer;
a time synchronization interface providing GPS or Precision Time Protocol time reference for nanosecond-level coordination with other edge units;
a processor configured to execute embedded edge software;
a configuration manager executed by the processor and configured to:
receive configuration packages through the communication interface;
perform integrity validation, compatibility validation, and range validation;
responsive to successful validation, execute an atomic rolling update to activate a new configuration without interrupting time-critical operations; and
transmit activation acknowledgment to the energy grid optimization computer.

6. The system of claim 5, each edge unit is further configured to:
continuously monitor communication link status with the energy grid optimization computer and time synchronization status;
responsive to losing communication with the energy grid optimization computer for more than a predetermined timeout period, automatically transition to an unconnected mode and activate a local safety-focused failsafe configuration;
responsive to degradation of time synchronization beyond an acceptable threshold, automatically transition to a connected but not synchronized mode with a modified configuration; and
execute a resynchronization protocol upon restoration of communication link and the time synchronization, wherein resynchronization comprises uploading buffered operational data and receiving an updated configuration.
